(19) United States
(12) Patent Application Publication
(10) Pub. No.: US 2014/0212982 A1
(43) Pub. Date: Jul. 31, 2014

(54) METHODS OF SELECTIVELY DETECTING THE PRESENCE OF A COMPOUND IN A GASEOUS MEDIUM

(71) Applicants: Alexander Moewes, Eagle Ridge (CA); John Anderson McLeod, Saskatoon (CA); Ernst Zagidovich Kurmaev, Yekaterinburg (RU); Igor Anatolievich Levitsky, Fall River, MA (US); Petr Sushko, Richland, WA (US); Teak Dagan Boyko, Saskatoon (CA)

(72) Inventors: Alexander Moewes, Eagle Ridge (CA); John Anderson McLeod, Saskatoon (CA); Ernst Zagidovich Kurmaev, Yekaterinburg (RU); Igor Anatolievich Levitsky, Fall River, MA (US); Petr Sushko, Richland, WA (US); Teak Dagan Boyko, Saskatoon (CA)

(73) Assignee: University of Saskatchewan, Saskatoon (CA)

(21) Appl. No.: 13/752,866

(22) Filed: Jan. 29, 2013

(51) Int. Cl. G01N 23/12

(52) U.S. Cl. CPC G01N 23/12
USPC 436/107; 378/53

(57) ABSTRACT

Methods of selectively detecting the presence of at least one compound in a gaseous medium. A silicon substrate can be exposed to the gaseous medium under conditions to adsorb the at least one compound to the silicon substrate to form a modified silicon substrate. The modified silicon substrate can be analyzed to determine if the at least one compound was present in the gaseous medium. The step of analyzing can include using X-ray spectroscopy.

### FIELD

The present disclosure relates generally to methods in which a silicon substrate is exposed to a gaseous medium, and the silicon substrate is analyzed to determine if at least one compound was present in the gaseous medium.

### SUMMARY

The following paragraphs are intended to introduce the reader to the more detailed description that follows and are not intended to define or limit the claimed subject matter.

The inventors of the present disclosure have observed that the electronic structure of mesoporous silicon can be affected by adsorption of compounds, for example, nitroaromatic and nitroamine compounds, such as nitro-based explosive compounds in a compound-selective manner. This selective response was studied by probing the adsorption of vapors of two nitro-based molecular explosives (trinitrotoluene and cyclotrimethylenetrinitramine) and a nonexplosive nitro-based aromatic molecule (nitrotoluene) on mesoporous silicon using soft X-ray spectroscopy, a technique which offers a direct, atom- and orbital-selective probe of local chemical bonding. The X-ray spectroscopic measurements were used to investigate the shift of the band edges of the mesoporous silicon upon exposure to the vapors of these adsorbents. The Si atoms were shown to strongly interact with adsorbed molecules to form Si—O and Si—N bonds, as evident from the large shifts in emission energy present in the Si L_{2,3} X-ray emission spectroscopy (XES) measurements. The energy gap (band gap) of mesoporous silicon was shown to change depending on the adsorbent, as estimated from Si L_{2,3} XES and 2p X-ray absorption spectroscopy (XAS) measurements.

The experimental observations were corroborated by ab initio molecular dynamics simulations and static energy minimization simulations using model compounds, which revealed atomic-scale mechanisms of the adsorption and decomposition of model molecules at amorphous silicon surfaces and the corresponding modifications to the electronic structure of the combined system. The ab initio molecular dynamics calculations suggest the changes are due to spontaneous breaking of the nitro groups upon contacting surface Si atoms. The compound-selective change in electronic structure can be used, for example, for the detection and identification of trace quantities of airborne compounds.

Accordingly, in an aspect of the present disclosure, a method of selectively detecting the presence of at least one compound in a gaseous medium is described. The method can include: exposing a silicon substrate to the gaseous medium under conditions to adsorb the at least one compound to the silicon substrate to form a modified silicon substrate; and analyzing the modified silicon substrate to determine if the at least one compound was present in the gaseous medium, wherein the step of analyzing includes using X-ray spectroscopy.

Furthermore, in an aspect of the present disclosure, a method of selectively detecting the presence of at least one compound in a gaseous medium is described, and in which the at least one compound includes at least one chemical moiety selected from the group consisting of a nitro group, a nitrite group, a peroxide group, an alcohol group, an amine group and a cyano group. The method can include: exposing a silicon substrate to the gaseous medium under conditions to chemically react the at least one chemical moiety with the silicon substrate and adsorb the at least one compound to the silicon substrate to form a modified substrate; obtaining an X-ray spectroscopic measurement of the modified substrate; and comparing the X-ray spectroscopic measurement of the modified substrate to an X-ray spectroscopic reference standard, in order to determine if the at least one compound was present in the gaseous medium.

Moreover, in an aspect of the present disclosure, a method of selectively detecting the presence of at least one compound in a gaseous medium is described, and in which the at least one compound is selected from the group consisting of para-nitrotoluene, 2,4,6-trinitrotoluene and cyclotrimethylenetrinitramine. The method can include: exposing a mesoporous silicon substrate to the gaseous medium under conditions to adsorb the at least one compound to the mesoporous silicon substrate to form a modified substrate; obtaining an X-ray spectroscopic measurement of the modified substrate; and comparing the X-ray spectroscopic measurement of the modified substrate to an X-ray spectroscopic reference standard, in order to determine if the at least one compound was present in the gaseous medium.

Other aspects and features of the teachings disclosed herein will become apparent, to those ordinarily skilled in the art, upon review of the following description of the specific examples of the present disclosure.

### BRIEF DESCRIPTION OF THE DRAWINGS

The drawings included herewith are for illustrating various examples of methods of the present disclosure and are not intended to limit the scope of what is taught in any way. In the drawings:

FIG. 1 shows the electronic structure calculated for select time steps in the DADNE-Si₂₉ simulation. The top curve shows the electronic structure for a pure Si₂₉ cluster; the time step of subsequent curves is noted. The thumbnail image to the right of each spectrum shows the geometry at that time step; these geometries are the same as those shown in FIG. 14. The evolution of the valence and conduction band edges is also shown by the dotted lines.

FIG. 2 shows the electronic structure calculated for the Si₂₉—Oₓ calculations (x=0 to 4). The thumbnail image to the right of each spectrum shows the geometry of that cluster. The energy gained by subsequent addition of oxygen atoms is shown by the bold arrows. This energy gain is calculated relative to half of the energy of an isolated O₂ molecule and the energy of an isolated Si₂₉—Oₓ₋₁ cluster. The evolution of the valence and conduction band edges is also shown by the dotted lines. It can be noted that increasing oxidation does not significantly change the band edges.

FIG. 3 shows the potential energy of the molecular dynamics calculations as initially performed with single point energy calculations, and then by fully relaxing the structures at the select time steps. The geometrical structures of the cluster at these time steps are shown in FIG. 14 and FIG. 1.

FIG. 4 shows exemplary silicon L_{2,3} XES spectra. FIG. 4A shows the similarity between low-porosity mesoporous silicon (LPSi) and crystalline silicon (c-Si), suggesting a low amount of oxidation in LPSi. FIG. 4B shows the similarity between high-porosity mesoporous silicon (HPSi) and SiO₂, suggesting that HPSi is almost fully oxidized. FIG. 4C shows that the spectrum of LPSi exposed to air saturated with TNT vapour (LPSi:TNT) is shifted away from the spectrum of SiO₂. FIG. 4D shows that the spectrum of LPSi exposed to air saturated with RDX vapour (LPSi:RDX) is shifted in the opposite direction from the spectrum of LPSi:TNT, i.e. towards lower energies.

FIG. 5 shows exemplary Si L_{2,3} XES and 2p XAS for LPSi samples compared to that of SiO₂. Energy shifts are noted on the spectra.

FIG. 6 shows exemplary Si L_{2,3} XES and 2p XAS for HPSi samples compared to that of SiO₂. Energy shifts are noted on the spectra. The trends in the treated HPSi samples are the same, but less clear, as the trends in the treated LPSi samples.

FIG. 7 shows exemplary O K XES and 1s XAS for LPSi samples compared to that of SiO₂.

FIG. 8 shows exemplary O K XES and 1s XAS for HPSi samples compared to that of SiO₂. The MgO calibration standard is also plotted; the arrow indicates the calibration energy for XAS. The Si 1s XAS in TEY mode is of poor quality because the thicker oxide layer on the HPSi samples makes them less conductive than the LPSi samples, which may lead to spectral artifacts due to surface charging.

FIG. 9 shows exemplary C K XES for LPSi and HPSi samples.

FIG. 10 shows exemplary silicon L_{2,3} XES and 2p XAS (TFY) spectra. The upper valence band edge of SiO₂ (estimated using the second derivative of the Si L_{2,3} XES spectrum of SiO₂) is shown by the dotted line at about 97.7 eV, and the main peak of the Si 2p XAS spectrum of SiO₂ is shown by the dotted line at about 108 eV. The pre-edge XAS spectral features at approximately 106 eV are aligned in all XAS spectra, including that of SiO₂. The second derivative of the Si L_{2,3} XES spectra near the valence band edge is plotted on top of the appropriate Si L_{2,3} XES spectra for the treated LPSi samples.

FIG. 11 shows exemplary oxygen K XES and 1s XAS spectra for LPSi treated with various adsorbents compared to SiO₂. The energy gap of SiO₂ is estimated using the second derivative of the XES and XAS spectra. The pre-edge features in the XAS spectrum for the treated LPSi samples have increased in intensity by a factor of 5. Both the bulk sensitive TFY and surface sensitive TEY modes are plotted for the O 1s XAS.

FIG. 12 shows exemplary carbon K XES spectra for LPSi treated with various adsorbents compared to amorphous carbon and SiC. The emission features at about 263 eV are due to second-order emission from oxygen.

FIG. 13 shows the time evolution of the system potential energy (left-most axis) and temperature (right-most axis) for the DADNE molecule interacting with the Si₂₉ cluster. The total energy of the system (also left-most axis) is approximately constant throughout.

FIG. 14 shows configurations of the DADNE-Si₂₉ system at several key stages during the MD simulation run. Panel O represents the original configuration. The letter of each panel identifies the simulation time step in FIG. 13 when the pictured event occurred.

FIG. 15 shows the calculated total density of states for the fully relaxed geometries of (a) final state of the dissociative adsorption of a DADNE molecule on the Si₂₉ cluster (at a simulation time of 12.073 ps), (b) Si₂₉—O₄ cluster, and (c) Si₂₉ cluster. The edges of the valence bands (E_{VB}) and conduction bands (E_{SB}) are shown by dotted lines.

### DETAILED DESCRIPTION

### I. Definitions

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

Unless otherwise indicated, the definitions and embodiments described in this and other sections are intended to be applicable to all embodiments and aspects of the disclosure herein described for which they are suitable as would be understood by a person skilled in the art.

As used in this disclosure, the singular forms “a”, “an” and “the” include plural references unless the content clearly dictates otherwise. For example, embodiments including “a compound” should be understood to present certain aspects with one compound, or two or more additional compounds.

In embodiments including an “additional” or “second” component, such as an additional or second compound, the second component as used herein is different from the other components or first component. A “third” component is different from the other, first, and second components, and further enumerated or “additional” components are similarly different.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% or at least ±10% of the modified term if this deviation would not negate the meaning of the word it modifies.

The term “X-ray spectroscopy” as used herein refers, for example, to a spectroscopic technique using X-ray excitation, and includes, for example, the collection and analysis of data. The selection of a suitable X-ray spectroscopic technique for analyzing, for example, a modified silicon substrate can be made by a person skilled in the art. For example, the X-ray spectroscopy can be X-ray emission spectroscopy (XES) and/or X-ray absorption spectroscopy (XAS). The X-ray spectroscopy can be used to obtain an “X-ray spectroscopic measurement”.

The term “X-ray spectroscopic measurement” as used herein refers, for example, to a measurement obtained using X-ray spectroscopy. The selection of a suitable X-ray spectroscopic measurement for example, for use in analyzing a modified silicon substrate can be made by a person skilled in the art. In some embodiments, the X-ray spectroscopic measurement can be based on an X-ray emission spectroscopy spectrum, for example, an Si L_{2,3} XES spectrum. In these embodiments, the X-ray spectroscopic measurement can be, for example, a peak energy position or a peak energy ratio. In other embodiments, the X-ray spectroscopic measurement can be based on a combined analysis of an X-ray absorption spectroscopy spectrum and an X-ray emission spectroscopy spectrum from the same atomic edge. For example, the change in an energy gap can be derived by comparing an Si L_{2,3} XES spectrum and an Si 2p XAS spectrum; i.e. in some embodiments, the change in energy gap can be based on an Si L_{2,3} XES spectrum and an Si 2p XAS spectrum.

The term “X-ray spectroscopic reference standard” as used herein refers, for example, to a previously obtained X-ray spectroscopic measurement of a first modified silicon substrate which can be used to compare to an X-ray spectroscopic measurement of a second modified silicon substrate to determine if a compound adsorbed to the second modified silicon substrate is the same compound as was adsorbed to the first modified silicon substrate. For example, the X-ray spectroscopic reference standard can include a previously obtained X-ray spectroscopic measurement of a silicon substrate modified by the adsorption of trinitrotoluene. In methods described herein, in the analyzing step, the X-ray spectroscopic measurement of the modified silicon substrate could then be compared to such an X-ray spectroscopic reference standard to determine if trinitrotoluene was present in the gaseous medium.

The term “porous silicon” as used herein includes, for example, microporous silicon, mesoporous silicon and nanoporous silicon.

The term “microporous silicon” as used herein refers, for example, to porous silicon having a pore size of greater than about 50 nm.

The term “mesoporous silicon” as used herein refers, for example, to porous silicon having a pore size of about 5 to about 50 nm. The selection of a suitable technique for the preparation of the required mesoporous silicon can be made by a person skilled in the art. For example, the mesoporous silicon can be prepared by an etching technique described, for example, by Levitsky et al.²⁵

The term “nanoporous silicon” as used herein refers, for example, to porous silicon having a pore size of less than about 5 nm.

The term “high porosity silicon” or “high porosity Si” or “high porosity mesoporous silicon” or “HPSi” as used herein refers, for example, to a mesoporous silicon having a surface pore density of about 50% to about 80% or about 75.2%.

The term “low porosity silicon” or “low porosity Si” or “low porosity mesoporous silicon” or “LPSi” as used herein refers, for example, to a mesoporous silicon having a surface pore density of about 30% to about 50% or about 43.5%.

The term “physisorption” as used herein refers, for example, to an adsorption of a molecule to a surface, for example, the adsorption of a compound to a silicon substrate, where there is a weak interaction between the molecule and the surface, for example, less than about 40 kJ/mol. In physisorption, the molecule adsorbed to the surface remains intact.

The term “chemisorption” as used herein refers, for example, to an adsorption of a molecule to a surface, for example, the adsorption of a compound to a silicon substrate, where there is a strong interaction between the molecule and the surface, for example, greater than about 40 kJ/mol. In chemisorption, the molecule adsorbed to the surface may not remain intact, for example, the molecule can fragment on the surface. This fragmentation can be referred to, for example, as “dissociative adsorption” or “dissociative chemisorption”.

The expression “at least one chemical moiety that chemically reacts with the silicon substrate” as used herein refers, for example, to a chemical moiety that can lead to dissociative adsorption of the compound including the at least one chemical moiety on the silicon substrate under the conditions to adsorb the at least one compound to the silicon substrate to form a modified silicon substrate in the exposing step of methods described herein. For example, the X-ray spectroscopic measurements and the ab initio molecular dynamics calculations of the present disclosure as detailed below support the feasibility of a dissociative adsorption of certain compounds having nitro groups on a silicon substrate. The selection of other chemical moieties that would chemically react with a silicon substrate under the conditions to adsorb the at least one compound to the silicon substrate to form a modified silicon substrate in the exposing step of the methods described herein can be made by a person skilled in the art. For example, a person skilled in the art would understand that a nitrite group is chemically similar to a nitro group. Other chemical moieties that can chemically react with a silicon substrate under the conditions to adsorb the at least one compound to the silicon substrate to form a modified silicon substrate in the exposing step of the methods of the present disclosure can include, for example, a peroxide group, an alcohol group, an amine group and a cyano group.

The term “nitro group” as used herein refers to a chemical moiety having the structure: —NO₂. The symbol “—” is used to indicate that the bond to the remainder of the molecular structure is formed with the nitrogen atom.

The term “nitrite group” as used herein refers to a chemical moiety having the structure: —O—N═O.

The term “peroxide group” as used herein refers to a chemical moiety having the structure: —O—O—.

The term “alcohol group” as used herein refers to a chemical moiety having the structure: —OH.

The term “cyano group” as used herein refers to a chemical moiety having the structure: —C≡N.

The term “benzene-based compound” as used herein refers to a compound including at least one benzene ring, which does not have at least one chemical moiety that chemically reacts with the silicon substrate. In some embodiments, the benzene-based compound can be selected from the group consisting of benzene and dichlorobenzene.

The term “explosive compound” as used herein refers, for example, to a chemical substance having a large amount of stored energy that can be released suddenly, thereby converting the chemical substance into, for example, a compressed gas that expands with, for example, great force or velocity. In some embodiments, the explosive compound can be a nitroexplosive. For example, the nitroexplosive can be selected from the group consisting of dinitrotoluene, trinitrotoluene, cyclotrimethylenetrinitramine, cyclotetramethylenetetranitramine, trinitrophenol, 1,1-diamino-2,2-dinitroethene, triaminotrinitrobenzene, nitroglycerin, ethylene glycol dinitrate, pentaerythritol tetranitrate, trinitrophenylmethylnitramine, hexanitrostilbene and 1,1-mercuric bis-5,5-nitrotetrazole. In some embodiments, the explosive compound can be a peroxide explosive. For example, the peroxide explosive can be triacetone triperoxide. In some embodiments, the explosive compound can be a nitrate explosive such as ammonium nitrate or urea nitrate.

The term “alkyl” as used herein, whether it is used alone or as part of another group, means straight or branched chain, saturated alkyl groups. For example, the term C₁₋₁₀alkyl means an alkyl group having 1, 2, 3, 4, 5, 6, 7, 8, 9 or 10 carbon atoms.

The term “NT” as used herein refers to the compound para-nitrotoluene:

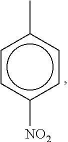

which can be used, for example, as a chemical solvent.

The term “TNT” as used herein refers to the compound 2,4,6-trinitrotoluene:

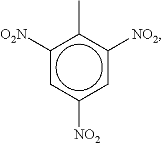

which can be used, for example, as a high explosive.

The term “RDX” as used herein refers to the compound cyclotrimethylenetrinitramine:

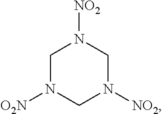 [SMILES: O=[N+]([O-])N1CN([N+](=O)[O-])CN([N+](=O)[O-])C1]

which can be used, for example, as a high explosive.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

### II. Introduction

The following paragraphs are not an admission that anything discussed in them is prior art or part of the knowledge of persons skilled in the art.

Several methods for detecting trace quantities of explosives have been reported.¹ However, the inventors of the present disclosure have recognized that a simple, compact, sensitive, selective, non-invasive, and low-cost sensor for explosives has not yet been achieved.

For example, it has been reported that a laser can be combined with a gas chromatograph to induce fragmentation of a target material and then analyze its gas-phase molecular fragments.² However, such a technique is not, for example, suited for non-destructive testing or monitoring of suspected material in situ, for example, in an airport luggage scanner.

Pulsed neutron analysis can be used to identify elements and to quantify, for example, the bulk C/O and N/O ratios characteristic to certain explosives.³ This technique is fast and can easily be applied to bulk materials but it requires pulsed neutron sources and γ-ray detectors.³ These devices can be made small enough, for example, to be deployed in field situations, but they are expensive and the detection procedure involves, for example, careful positioning of the device with respect to the suspect material to be tested.

Handheld detectors could also, for example, be realized by utilizing ion mobility spectrometry. However, issues such as maintaining a stable ion source and avoiding false positives from gas-phase ion-molecule fragments are still to be resolved in methods using such a technique.⁴

Single-walled carbon nanotube field effect transistors have been reported to show changes in resistivity in the presence of single molecules, for example, glucose and DNA.^{5,6} Single electron carbon nanotube transistors (CN SETs) have been reported to change resistance in the presence of TNT.⁷ However, this is non-reversible and CN SETs are expensive.

A solid-acid catalyst has been reported to be sensitive to triacetone triperoxide vapor.⁸ However, the sensitivity of this solid-acid catalyst to other explosives has not yet been demonstrated.

Sources and detectors useful for optical spectroscopy are typically not expensive and widely available. However, many spectroscopic techniques, for example, Raman and IR spectroscopy often require relatively large quantities of a material, positioned between the source and the detector, which may, for example, create difficulties in the practical application of these techniques.

For example, the low vapor pressure of most explosives⁹ can, for example, make accurately detecting these compounds through adsorption or Raman spectroscopy quite difficult², since the signal-to-noise ratio in practical settings is often rather low. Surface-enhanced Raman spectroscopy has been reported to detect low concentrations of dinitrotoluene (DNT) and trinitrotoluene (TNT) adsorbed in alumina nanopores containing gold nanoparticles.¹⁰ However, the detection sensitivity is highly dependent on the surface properties.²

A sensitive method for detecting nitroexplosives based on the luminescence quenching of emissive conjugated polymers (or amplifying polymers) has been developed by Yang and Swager.¹¹ This approach is capable of detecting TNT vapors in the particle per trillion (ppt) range and even lower. The fluorescence quenching of a wide variety of molecules with nitro groups has been studied, including TNT and DNT, and the authors reported differences in quenching for different molecules.¹¹ Other reports of the use of fluorescence quenching of, for example, conjugated polymer layers and semiconductive organic polymers to detect nitroexplosives can also be found in the literature^{12,13,14,15} and conjugated polymer sensitivity to various nitroexplosives in solution has also been demonstrated.¹⁶ However, the selectivity of such methods may not be sufficient for differentiating between structurally related explosive compounds and non-explosive compounds, as, for example, many nonexplosive nitroaromatic compounds can also induce luminescence quenching.

Thus, there is clearly a need for a material that can quickly and selectively accumulate a compound, for example, an explosive compound at a sufficiently high density under practical conditions and that can noticeably change its properties under the influence of the compound to ultimately selectively detect and identify the specific compound present.

Porous silicon, for example nanoporous silicon, mesoporous silicon, or microporous silicon is an attractive material for chemical sensing because, for example, it has a high surface area (it can have a surface-to-volume ratio of up to about 1000 m² cm⁻³), silicon-based microfabrication technologies are readily available, and it has been reported to have a variety of transduction mechanisms associated with its electrical, optical, and chemical properties. For example, it has been shown that the photoluminescence of porous silicon can change, for example, due to surface effects and/or nanostructured silicon crystallites¹⁷ and due to the adsorption of molecules onto the silicon surface.^{18,19,20,21,22,23} It has also been reported that the resistivity of PSi can be modified by several orders of magnitude by the adsorption of dielectric liquids.²⁴

The possibility of using porous silicon in optical sensors for vapor detection has been reported. The adsorption of the target molecules into the silicon pores modifies the refractive index and consequently the optical properties of the porous silicon. For example, optical sensors based on porous mono/double layers, Bragg mirrors, luminescent and reflective microcavities (MCs) have been reported in the literature.^{25,26,27,28,29,30,31,32,33} The use of porous silicon in gas sensors based on, for example, resistivity, resistance, impedance, capacitance or conductance measurements has also been reported.^{34,35,36,37,38,39,40,41}

Porous silicon has been shown to have sub-ppm sensitivity to NO and NO₂ gas.⁴² For example, an NO₂ sensor using changes in conductance of porous silicon has been reported to work well in a range of ambient temperatures and humidities.^{43,44,45} It has also been reported that aged porous silicon shows greater reversibility to NO₂ detection and less sensitivity to air moisture.⁴⁶ It has been reported that there is some chemisorption occurring during the interaction of NO₂ and porous silicon⁴⁷ and the surface of the porous silicon changes upon nitridization and oxidization during this process.

Levitsky et al. have reported an optical sensor that can detect, for example, nitrotoluene, cyclotrimethylenetrinitramine, pentaerythritol tetranitrate and TNT vapor using a porous silicon microcavity infiltrated with a conjugated fluorescent sensory polymer.^{25,48} Levitsky reports the unique combination of the sensory organics and nanoporous photonic crystal provides the high selectivity in the system, allowing it to distinguish between the different compounds.⁴⁸ Levitsky et al. reported no response in the microcavity resonance peak in the reflectance spectrum upon exposure of an “empty” microcavity to TNT saturated vapor.²⁵

Content et al. have reported the detection of nitroaromatic molecules such as nitrobenzene, 2,4-dinitrotoluene and 2,4,6-trinitrotoluene in air by the quenching of the photoluminescence of porous silicon films.⁴⁹ To discriminate the nitro-containing molecules DNT and TNT from other organic species not containing nitro groups, a step including the catalytic oxidation of the nitroaromatic compound was carried out, but no discrimination could be obtained by the use of a catalyst with nitrobenzene.⁴⁹ The purity of the TNT sample was found to be important to obtain reproducible results.⁴⁹

In addition to explosive compounds, there also remains a need for a non-invasive, for example, contact-less method of selectively detecting the presence of other types of compounds in a gaseous medium.

### III. Methods

In the studies described herein, the interaction of low porosity Si with saturated vapors of NT, TNT, and RDX molecules, all of which contain nitro groups, has been investigated. The changes in the surface electronic structure have been characterized using a combination of spectroscopic measurements for both pre-oxidized LPSi and LPSi exposed to the NT, TNT, or RDX vapors. The Si L_{2,3} XES and 2p XAS, the C K XES, and the O K XES and 1s XAS spectra show changes in the surface electronic structure of LPSi, which points to dissociative adsorption of the molecules. Ab initio molecular dynamics calculations support the feasibility of this dissociative adsorption and provide insight into mechanisms on the atomic scale of silicon oxidation and nitrogenation. These calculations also suggest pathways of simultaneous decomposition of the adsorbed molecules. Furthermore, the ab initio electronic structure calculations support the feasibility of dissociative adsorption driving changes in the valence and conduction band edges. In spite of the similarity in the dissociative nature of the molecular adsorption, the changes to the LPSi electronic structure are clearly molecule-specific. In particular, the estimated values of the surface energy gap decreases as the number of nitro functional groups increases for adsorbents containing aromatic rings, such as NT and TNT. On the contrary, the surface energy gap increases for adsorbents containing nitroamine groups, such as RDX. This suggests the relative energy shifts and, therefore, selectivity towards the adsorbed molecules are not due to adsorption of nitro groups alone, but due to adsorption of nitro-amine groups (from the dissociated RDX molecules), and aromatic rings or methyl groups (from the dissociated NT or TNT molecules) on the surface of LPSi. The strong changes in the electronic structure of LPSi that are observed after adsorption of a particular molecule support the feasibility of LPSi as a material for the detection and identification of trace amounts of airborne compounds.

Generally, in accordance with various embodiments of the present disclosure, a method of selectively detecting the presence of at least one compound in a gaseous medium can include: providing a gaseous medium, the gaseous medium including at least one compound; providing a silicon substrate; and exposing the silicon substrate to the gaseous medium under conditions to adsorb the at least one compound to the silicon substrate to form a modified silicon substrate. The method can further include analyzing the modified silicon substrate to determine if the at least one compound was present in the gaseous medium. The step of analyzing can include using X-ray spectroscopy.

For example, the conditions to adsorb the at least one compound to the silicon substrate to form a modified silicon substrate can include, for example exposing the silicon substrate to a gaseous medium including a vapor of the at least one compound at a temperature of above about 0° C. in atmosphere at an ambient pressure (i.e. warm enough to prevent ice forming on the PSi surface) or a lower temperature, for example, in a vacuum or under an ambient pressure of dry nitrogen for a time of about 5 minutes to about 45 minutes. In embodiments of the present disclosure, the temperature is about 25° C. and the time is about 30 minutes. Adsorption can be enhanced at elevated temperatures. For example, if the at least one compound includes NT and/or TNT, the elevated temperature can be about 70° C. For example, if the at least one compound includes RDX, the elevated temperature can be about 120° C.

In some embodiments of the present disclosure, the step of analyzing can include obtaining an X-ray spectroscopic measurement of the modified silicon substrate, and comparing the X-ray spectroscopic measurement of the modified silicon substrate to an X-ray spectroscopic reference standard.

In some embodiments, the X-ray spectroscopic measurement can be obtained using X-ray emission spectroscopy (XES). For example, the X-ray spectroscopic measurement can be based on an Si L_{2,3} XES spectrum, and can be a peak energy position or a peak energy ratio. In some embodiments, the X-ray spectroscopic measurement can be obtained using X-ray absorption spectroscopy (XAS). In some embodiments of the present disclosure, the X-ray spectroscopic measurement can be obtained using XES and XAS. For example, the X-ray spectroscopic measurement can be a change in an energy gap, and the change in the energy gap can be based on an Si L_{2,3} XES spectrum and an Si 2p XAS spectrum.

In some embodiments, the silicon substrate can include a mesoporous silicon, a nanoporous silicon or a microporous silicon. In some embodiments, the silicon substrate can consist essentially of a mesoporous silicon, a nanoporous silicon or a microporous silicon. In some embodiments, the silicon substrate can consist of a mesoporous silicon, a nanoporous silicon or a microporous silicon.

In some embodiments, the silicon substrate can include a mesoporous silicon. In some embodiments, the silicon substrate can consist essentially of a mesoporous silicon. In some embodiments, the silicon substrate can consist of a mesoporous silicon.

In some embodiments, the silicon substrate can include a high porosity mesoporous silicon. In some embodiments, the silicon substrate can consist essentially of a high porosity mesoporous silicon. In some embodiments, the silicon substrate can consist of a high porosity mesoporous silicon.

In some embodiments, the silicon substrate can include a low porosity mesoporous silicon. In some embodiments, the silicon substrate can consist essentially of a low porosity mesoporous silicon. In some embodiments, the silicon substrate can consist of a low porosity mesoporous silicon.

In some embodiments, the method can further include, prior to the step of exposing, subjecting the silicon substrate to conditions to oxidize a surface thereof. In some embodiments, the conditions to oxidize a surface thereof can include subjecting the silicon substrate to an elevated temperature, for example a temperature of about 400° C. to about 1000° C., or about 900° C. for a time of about 5 minutes to about 120 minutes, or about 20 minutes under a flow of, for example, oxygen gas. For silicon substrates that are stable in the presence of oxygen, like the LPSi substrates discussed herein, an oxidation step is generally not necessary.

In some embodiments, the at least one compound can be adsorbed to the silicon substrate through a chemisorption mechanism. In some embodiments, the at least one compound can be adsorbed to the silicon substrate through a physisorption mechanism. In some embodiments, the at least one compound can be adsorbed to the silicon substrate through a chemisorption mechanism and a physisorption mechanism. For example, some molecules of an at least one compound can be adsorbed through a chemisorption mechanism and other molecules of the at least one compound can be adsorbed through a physisorption mechanism. Alternatively, at least one compound can be adsorbed through a chemisorption mechanism and at least one compound can be adsorbed through a physisorption mechanism.

In some embodiments of the present disclosure, the at least one compound can include at least one chemical moiety that chemically reacts with the silicon substrate in the step of exposing to form the modified silicon substrate. For example, the at least one compound can include at least one chemical moiety that chemically reacts with the silicon substrate selected from the group consisting of a nitro group, a nitrite group, a peroxide group, an alcohol group, an amine group and a cyano group.

For example, where the at least one chemical moiety that chemically reacts with the silicon substrate is a nitro group, the at least one compound can be selected from the group consisting of nitramide, nitrobenzene, nitromethane, nitrotoluene, dinitrotoluene, trinitrotoluene, cyclotrimethylenetrinitramine, cyclotetramethylenetetranitramine, trinitrophenol, 1,1-diamino-2,2-dinitroethene, triaminotrinitrobenzene, nitroglycerin, ethylene glycol dinitrate, pentaerythritol tetranitrate, trinitrophenylmethylnitramine, hexanitrostilbene and 1,1-mercuric bis-5,5-nitrotetrazole.

For example, where the at least one chemical moiety that chemically reacts with the silicon substrate is a nitrite group, the at least one compound can be selected from the group consisting of amyl nitrite, methyl nitrite and ethyl nitrite.

For example, where the at least one chemical moiety that chemically reacts with the silicon substrate is an alcohol group, the at least one compound can be C₁₋₁₀alkyl-OH. For example, the C₁₋₁₀alkyl-OH can be selected from the group consisting of methanol, ethanol and isopropanol.

For example, where the at least one chemical moiety that chemically reacts with the silicon substrate is a peroxide group, the at least one compound can be triacetone triperoxide.

Accordingly, in some embodiments, the at least one compound is selected from the group consisting of nitramide, nitrobenzene, nitromethane, nitrotoluene, dinitrotoluene, trinitrotoluene, cyclotrimethylenetrinitramine, cyclotetramethylenetetranitramine, trinitrophenol, 1,1-diamino-2,2-dinitroethene, triaminotrinitrobenzene, nitroglycerin, ethylene glycol dinitrate, pentaerythritol tetranitrate, trinitrophenylmethylnitramine, hexanitrostilbene, 1,1-mercuric bis-5,5-nitrotetrazole, amyl nitrite, methyl nitrite, ethyl nitrite, methanol, ethanol, isopropanol and triacetone triperoxide.

In some embodiments, the at least one compound is selected from the group consisting of para-nitrotoluene, 2,4,6-trinitrotoluene and cyclotrimethylenetrinitramine.

In some embodiments, in the step of exposing, the at least one compound is not capable of reacting with the silicon substrate under the conditions to adsorb the at least one compound to the silicon substrate. In some embodiments, the at least one compound not capable of reacting with the silicon substrate under the conditions to adsorb the at least one compound to the silicon substrate is a benzene-based compound. In some embodiments, the benzene-based compound is selected from benzene and dichlorobenzene.

The methods of the present disclosure can be utilized in various applications. The methods can be used in: the spacecraft industry, for example, for the detection of compounds degassing from plastics; the safety and security industries, for example, for airport screening; remote monitoring in heavy industry, for example, for trace leakage of volatile chemicals; remote monitoring of environmental areas, for example, for specific types of pollution; the space and satellite industry, for example, for the detection of particles in a vacuum; military applications, for example, as a distributed passive detection grid in conflict areas to monitor the presence and movement of munitions and explosives; for detecting refrigerant gases, for example, chlorofluorocarbons; and domestic uses, for example, as a multipurpose alarm, for detecting compounds that would be predicted to be adsorbed to the silicon substrate to give a modified silicon substrate that could be analyzed using X-ray spectroscopy to determine if such a compound was present in a gaseous medium. For example, in some embodiments of the present disclosure, compounds likely to leave behind a unique molecular fragment having about 50 atoms or less after dissociative adsorption may be distinguishable from each other. For example, in some embodiments, NT and TNT can be distinguished from each other. In some embodiments of the present disclosure, compounds having greater than about 50 atoms after dissociative adsorption are expected to be detectable. This process can include simple molecules that may adsorb without any dissociation. For example, in some embodiments, dimethyl nitroamine may adsorb without dissociation, and may be distinguished from, for example, NT and TNT. This process may exclude adsorption, whether dissociative or not, of very large macromolecules, for example proteins.

Accordingly, in some embodiments of the present disclosure, the at least one compound can be an explosive compound. In some embodiments, at least one of the at least one compound can be an explosive compound and at least one of another at least one compound can be a non-explosive compound. For example, the explosive compound and non-explosive compound may have chemically similar structures, for example, the explosive compound can be TNT and the non-explosive compound can be para-nitrotoluene.

### IV. Examples

Reference is now made to the following examples of the present disclosure involving a selective response of mesoporous silicon to adsorbents with nitro groups, which are intended to be illustrative but non-limiting.

(a) Materials and Methods

### Preparation of Mesoporous Silicon

PSi was prepared by the common etching technique, described in detail elsewhere.^{25,50} In brief, PSi was fabricated by electrochemical etching of crystalline silicon (c-Si) with a hydrofluoric acid (HF) solution. The resulting etched layer can have a pore size which can vary from several nm to hundreds of nm depending on the Si doping level, the solution composition, and current density.⁵¹ For the purpose of the present study, PSi monolayers were prepared by anodic etching of p-type (100)-oriented Si wafers with a resistivity of about 0.01 Ω·cm in a 15% solution of HF with ethanol. High porosity Si (HPSi) and low porosity Si (LPSi) layers were prepared under current densities of 60 mA/cm² and 5 mA/cm², respectively. The resulting surface pore densities were 75.2% for HPSi and 43.5% for LPSi. The porosity was measured by the gravimetric method. All of the PSi wafers of the present study had mesoscale-sized pores; i.e. pore sizes from about 5 to about 50 nm. The PSi surfaces were oxidized at 900° C. under an oxygen flow for 20 minutes followed by exposure to a saturated vapor of TNT, NT or RDX at elevated temperatures in sealed vials for 30 min (70° C. for TNT and NT and 120° C. for RDX). These treated PSi samples were then removed from the vials and placed under ultra-high vacuum (UHV) for the X-ray spectroscopy measurements.

### X-Ray Spectroscopy

X-ray emission spectroscopy (XES) and X-ray absorption spectroscopy (XAS) was performed, probing the occupied and unoccupied states, respectively. The XAS measurements were performed in both the bulk-sensitive total fluorescence yield (TFY) mode, and the surface-sensitive total electron yield (TEY) mode. The samples were removed from the saturated vapor and measured under ultra-high vacuum with no further preparation.

In addition to element sensitivity, X-ray spectroscopy measurements also probe different depths in these samples. The XES and TFY mode XAS measurements have the same effective probe depth, for the Si L_{2,3} and 2p, C K and 1s, and O K and 1s edges the measurements probe the samples to depths of about 60 nm, 100 nm and 500 nm, respectively.⁵² The TEY mode XAS measurements are much more surface sensitive and only probe to a depth of about 1.5 nm for all edges measured in the present study.⁵³

The XES measurements were performed at the soft X-ray fluorescence endstation of Beamline 8.0.1 at the Advanced Light Source at Lawrence Berkeley National Laboratory.⁵⁴ The endstation uses a Rowland circle geometry X-ray spectrometer with spherical gratings and an area sensitive multichannel detector. Nonresonant Si L_{2,3} (probing the 3s3d→1s transition) and C and O K (probing the 2p→1s transition) XES measurements were performed. The instrumental resolving power (E/ΔE) for the XES measurements was about 10³. The non-resonant excitation energies for the XES measurements were chosen well above Si 2p, C 1s and O 1s absorption features.

The XAS measurements were performed at the Canadian Light Source. Measurements of O 1s XAS (probing the 1s→2p transition) were performed at the Spherical Grating Monochromator beamline,⁵⁵ and Si 2p XAS (probing the 2p→3s3d transition) was measured at the Variable Line-Spacing Planar Grating Monochromator beamline.⁵⁶ The E/ΔE for all XAS spectra was about 5×10³. All spectra were normalized to the incident photon current using a highly transparent mesh in front of the sample to correct for intensity fluctuations in the photon beam. The Si 2p XAS was measured in the surface sensitive total electron yield (TEY) mode, while the O 1s XAS was measured both in TEY and in the bulk sensitive total fluorescence yield (TFY) mode. While Si K XES and 1s XAS is an option, the higher energy and correspondingly deeper penetration depths of these measurements makes them less sensitive to surface changes. Si 1s XAS of porous silicon has been reported in the literature.⁵⁷

Untreated c-Si was retained as a reference sample. Commercially available (Alfa Aesar, 99.9% purity) amorphous SiO₂ (density ρ˜2:2 g/cm³), α-SiC, and carbon tape as an example of amorphous carbon (a-C) were also used as reference materials. These were mounted in the UHV chamber for X-ray spectroscopy measurements without any additional treatment.

### Soft X-Ray Spectroscopy Calibration

The soft X-ray spectroscopy measurements were calibrated using reference standards. These reference standards were shifted to match energies used previously in the literature.

SiO₂ was used as the calibration standard for the Si X-ray spectroscopy measurements. The main peak of the Si 2p XAS in SiO₂ was aligned to 108.0 eV.⁵⁸ The main peak of the Si L_{2,3} XES in SiO₂ was aligned to 94.8 eV.⁵⁹ No direct check (i.e. by measuring the elastic excitation peak) was performed to verify that these two calibrations were consistent with each other. It is therefore possible that the relative alignment between the Si L_{2,3} XES and 2p XAS could be incorrect. The only implication of this is that the band gap estimates using the Si L_{2,3} XES and 2p XAS could be incorrect by a fixed value. This offset between the correct gap and the measured gap would be the same for all samples. The important aspect of these measurements, that is the spectral differences and energy shifts between the various Si L_{2,3} XES measurements and between the various Si 2p XAS measurements would not be affected by any offset in the calibration.

MgO was used as a calibration standard for the O X-ray spectroscopy measurements. MgO 1s XAS was measured both on BL8 at the ALS and at SGM at the CLS (only XAS from the CLS is reported here, since it is higher resolution than that from the ALS). A post-edge peak of the MgO O 1s XAS (TFY mode) was shifted to 546.7 eV,⁶⁰ while the main peak of the MgO O K XES was shifted to 525.5 eV.⁶¹ The relative calibration was checked by exciting near the O 1s XAS threshold and observing the elastic scatter peak in the O K XES. The relative calibration between the XES and XAS measurements is therefore accurate within the instrumental resolution.

The C K XES was calibrated using the second order oxygen emission lines. Since the main peak of the O K XES was previously determined to be 526.6 eV, the corresponding second order emission line in the C K XES spectrum was aligned to 263.3 eV. Since the C K XES spectra were not compared to C 1s XAS spectra, the absolute calibration is not terribly important.

### Theoretical Calculations

The DADNE-Si₂₉Oₓ and DMNA-Si₂₉Oₓ (x=0, 4) systems were investigated using the ab initio molecular dynamics (MD) method, in which atoms obey Newtonian equations of motion. The system's total energies and the forces acting on atoms are calculated using the generalized gradient corrected density functional by Perdew, Burke, and Ernzerhof (PBE)⁶² and the projected augmented waves method.⁶³ The calculations were performed using the Vienna ab initio simulation package (VASP).⁶⁴ The system was modeled using periodic boundary conditions and a cubic supercell with the lattice constant of 18 Å. A single k-point (Γ) has been used for Brillouin zone integration. The constant total energy ensemble and 1 fs timestep were used for the MD production runs.

The electronic structure modifications of these systems have been analyzed using the densities of states (DOS) calculated for judiciously selected MD snapshot configurations. In other to eliminate the effects of the thermal noise, the energy of each configuration has been fully minimized with respect to the atomic coordinates at the B3LYP/6-31G(d) level of theory and using the Gaussian 03 package.⁶⁵ The DOS was obtained as a convolution of Gaussian-type functions (FWHM=0.5 eV), each representing a single one-electron state.

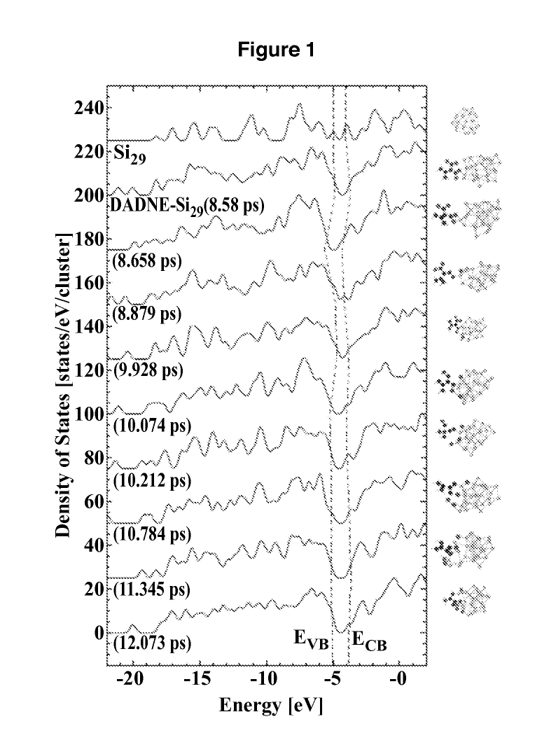

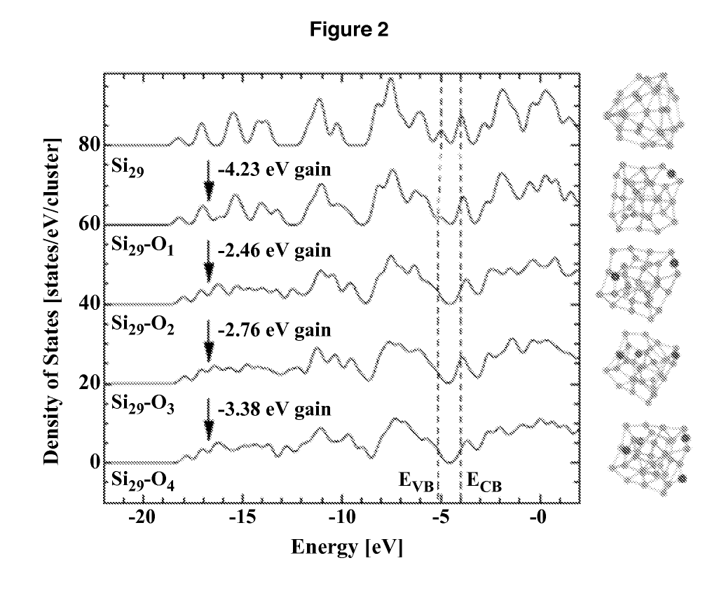

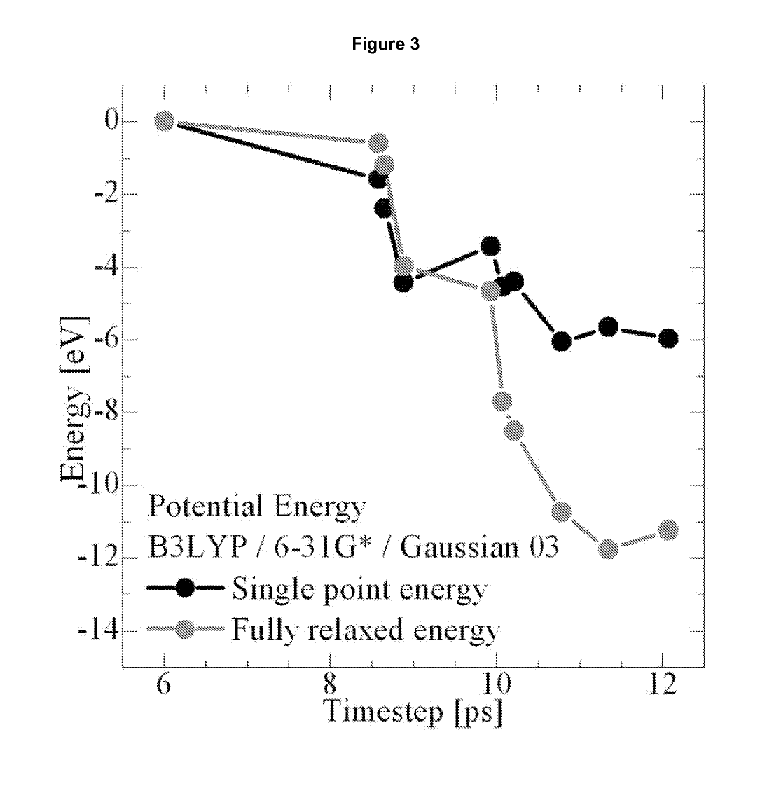

The electronic structure for select time steps in the DADNE-Si₂₉ simulation, and for 1 to 4 oxygen atoms in the Si₂₉—Oₓ calculation are shown. These spectra were broadened with Gaussians with a full width at half maximum of 0.5 eV. Thumbnail images of the cluster geometrical structures are also shown for each electronic structure spectrum. See FIGS. 1-3.

(b) Results

### Silicon X-Ray Spectroscopy

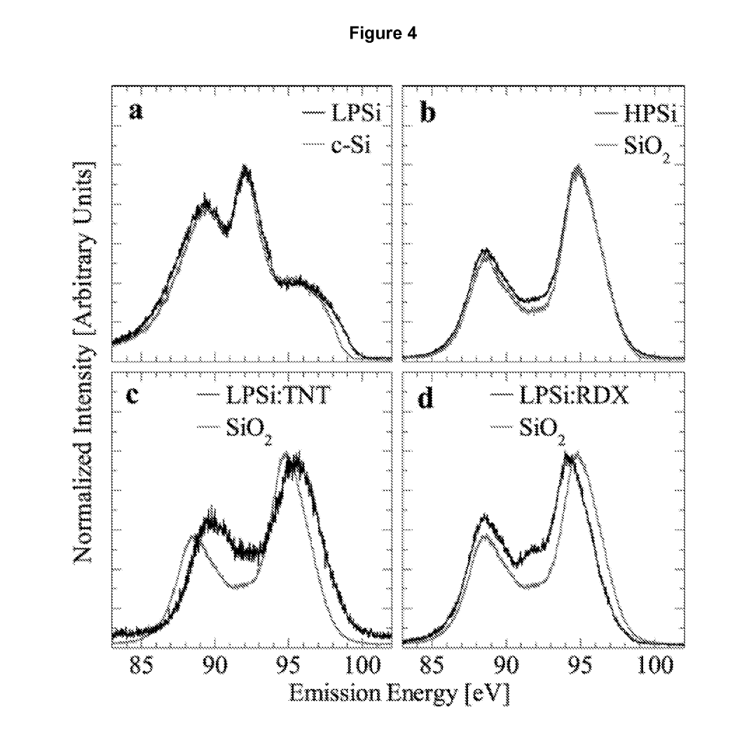

It is known that porous silicon as a chemically active, high surface-to-volume ratio material can be easily oxidized.⁶⁶ The microporous (with a pore size greater than about 50 nm), mesoporous (pore size of about 5-50 nm) or nanoporous (pore size less than about 5 nm) silicon layers can be bare, partially oxidized (when Si domains are embedded into an oxide matrix), or fully oxidized. These different forms of porous silicon have distinctly different physical properties, and their characteristics may vary during ageing due to, for example, oxidation and hydroxylation processes.⁶⁷ With this in mind, the Si L_{2,3} XES spectra of LPSi and HPSi can be examined. As shown in FIG. 4, the Si L_{2,3} XES spectrum of LPSi is almost the same as that of bulk crystalline Si (c-Si), whereas the Si L_{2,3} XES spectrum of HPSi is almost the same as the spectrum of SiO₂. This means that HPSi can be considered, for the purposes of the present study, to be fully oxidized and its surface wholly composed of SiO₂.

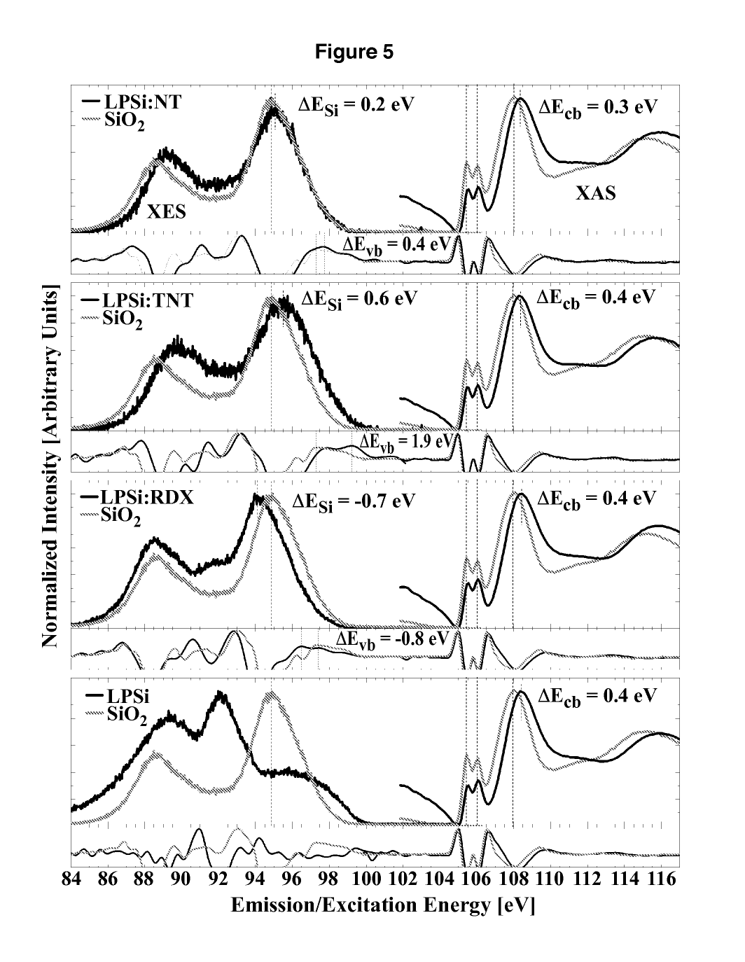

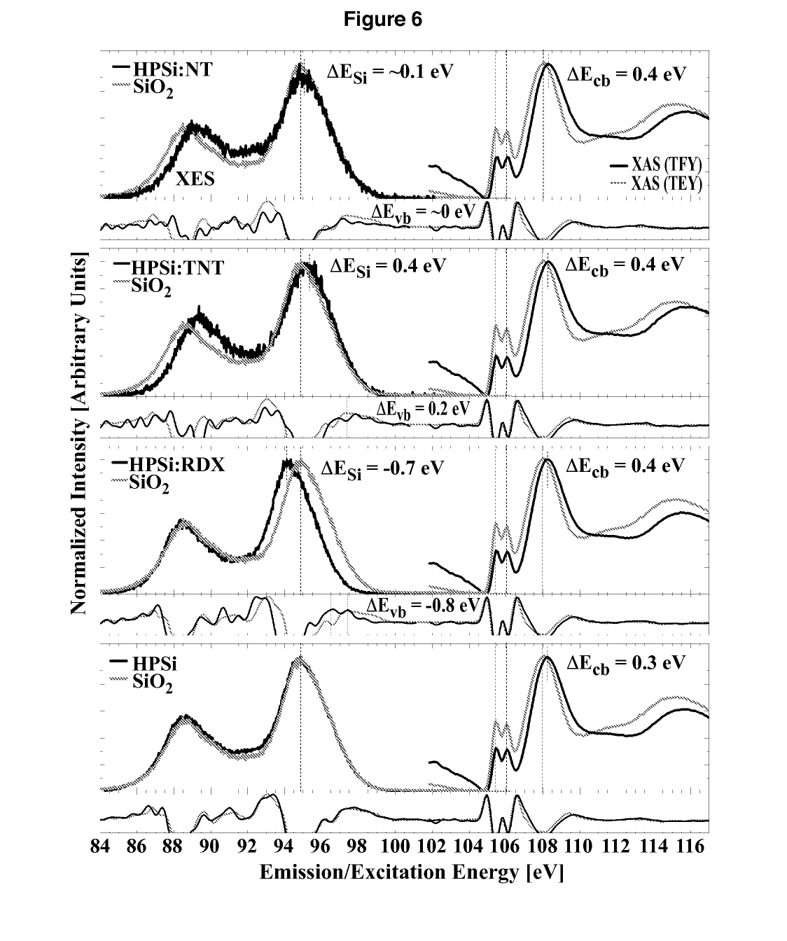

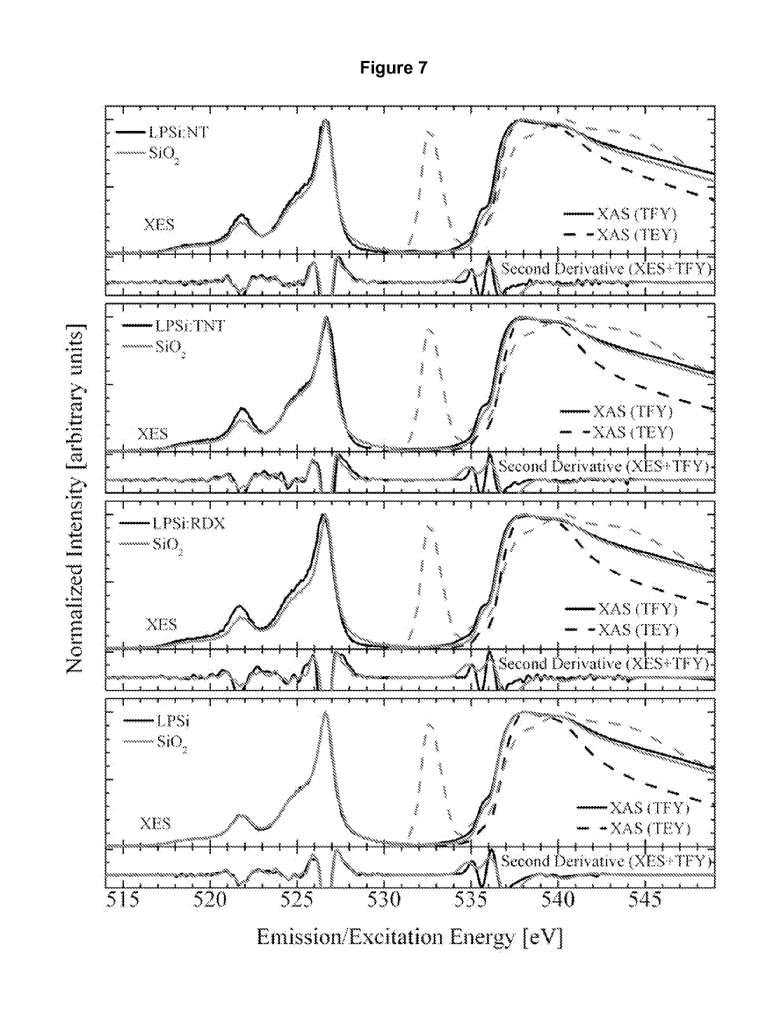

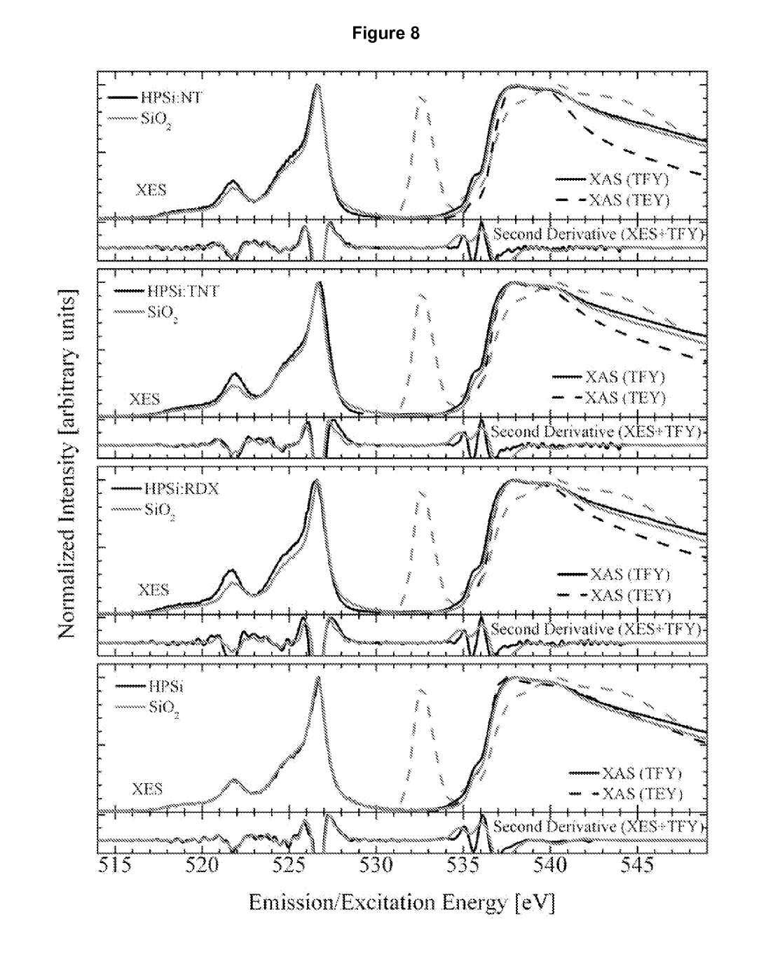

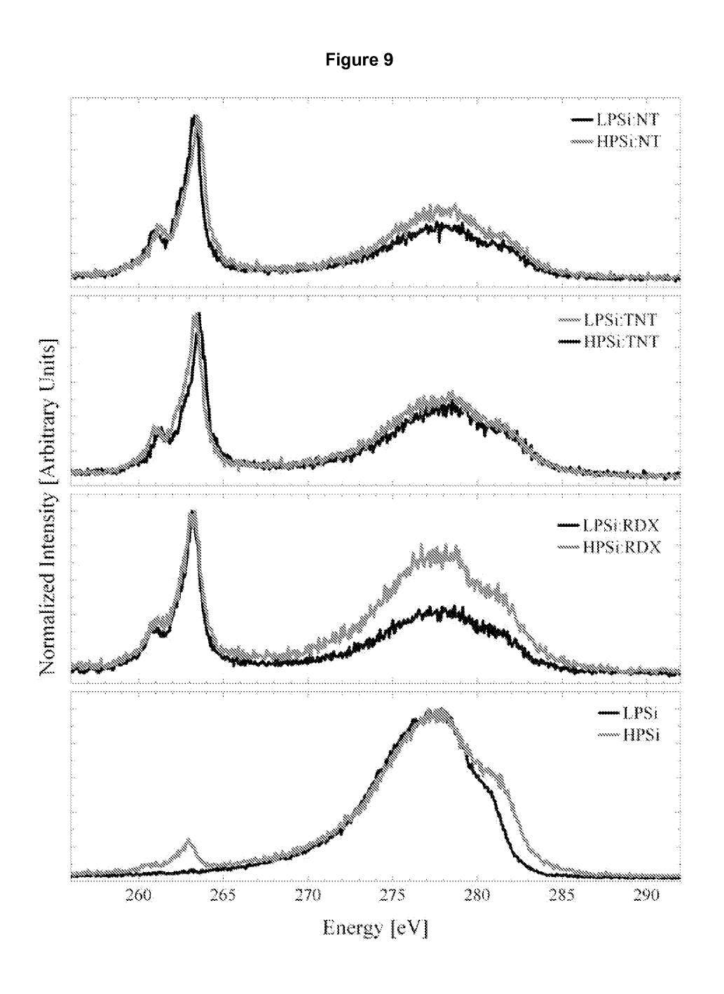

The Si L_{2,3} XES and 2p XAS, O K XES and 1s XAS, and C K XES are shown for LPSi and HPSi after oxidation and exposure to NT, TNT, or RDX molecules are shown in FIGS. 5-9. The spectroscopy measurements of NT, TNT, and RDX adsorbed on HPSi show the same trends as the corresponding measurements on LPSi, but the magnitude of the spectral changes is smaller. While not wishing to be limited by theory, this is due to the thicker oxide layer in HPSi compared to LPSi, and the corresponding low chemical sensitivity of the HPSi surface. Hence HPSi is not considered in the following discussion.

The Si L_{2,3} XES spectrum of LPSi shows that it is primarily pure silicon within 60 nm of the surface despite being oxidized for 20 min at 900° C. To rationalize this result, it is noted that the volume of SiOₓ (0<x) per Si atom is larger than that of pure silicon, which leads to build up of the lattice stress during Si oxidation and which is known to decrease the oxidation rate and result in formation of rough films.⁶⁸ At temperatures above 1050° C., viscous flow of SiO₂ suppresses this stress and its effect on the oxidation rate.⁶⁸ However, in the present case, the viscous flow contribution is negligible and, consequently, accumulated stress suppresses further oxidation. Moreover, earlier experimental⁶⁹ and theoretical⁷⁶ studies have demonstrated that oxidation of concave surfaces, a typical geometry for pores in LPSi, progresses at a much lower rate than oxidation of flat surfaces. Thus, while not wishing to be limited by theory, it is reasonable to suggest that the oxidized areas primarily form “islands” in the regions between pores, leaving the Si inside the pores exposed. Indeed, previous atomic force microscopy characterization of oxidized porous silicon shows that the oxide layer tends to form on the needle-like peaks on the porous silicon surface, rather than in the pores.⁷¹ An additional consideration is that the low pore density might allow an oxide layer to coat the entire surface, sealing off the tops of the pores.⁷² However, after the LPSi is cooled, the induced stress on this layer could fracture it, thus exposing the pure silicon pores.

A dramatic change is seen in the Si L_{2,3} XES spectra after exposing LPSi to nitro-based molecules. The fine structure in the spectrum of untreated LPSi is strongly modified and instead of the three features typical for c-Si, the spectra of LPSi exposed to the nitrogen compounds consist of two main peaks which are closer to the spectrum of SiO₂. Of the three treated materials, the spectrum of the substrate exposed to NT (LPSi:NT) is the most similar to that of SiO₂ (in energy position and peak ratio). The spectrum of the substrate exposed to TNT (LPSi:TNT) shows an energy shift compared to SiO₂, with the high energy XES peak shifted to higher energies (see FIG. 4). The spectrum of the substrate exposed to RDX (LPSi:RDX) is shifted to lower energies with respect to that of SiO₂, that is, shows the opposite shift in energy compared to LPSi:TNT. The foregoing data suggests that the surface of LPSi interacts strongly with the adsorbent molecules and the effect of this interaction on the Si electronic structure depends on the molecule.

The large magnitude of the energy shifts evident in the Si L_{2,3} XES spectra is very surprising, especially since the LPSi substrate was only exposed to a vapor of NT, TNT, or RDX molecules. These shifts are also seen somewhat in HPSi after exposure to these molecules (the shift is less apparent, due to the aforementioned lower chemical activity, but the trends are consistent with those seen in LPSi). The energy shifts in the Si L_{2,3} XES spectra make a strong case for the sensitivity of the electronic properties of PSi to adsorbed molecules.

### Surface Energy Gaps

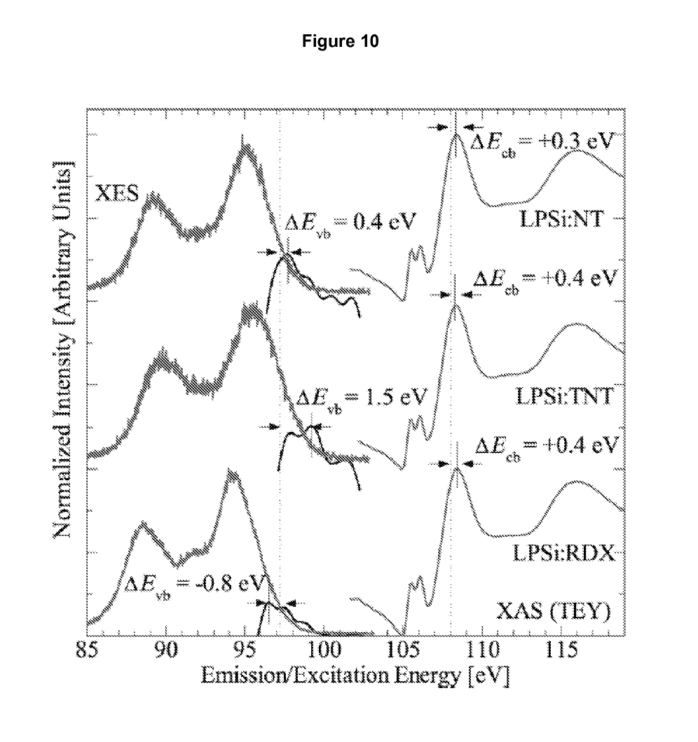

The changes in the surface energy gap can be estimated by comparing the Si L_{2,3} XES and 2p XAS spectra, as shown in FIG. 10. Note that while the 60 nm penetration depth of the Si L_{2,3} XES measurements would normally make this a bulk measurement, because the pores are usually a few hundred nm deep^{73,74} and because the Si L_{2,3} XES clearly shows a sensitivity to the vapor treatment of the samples, the Si L_{2,3} XES can be considered as a surface sensitive measurement. Using the main peaks of the second derivative of the complementary XES and XAS spectra of the oxygen K edge has been shown to give a good estimate of the energy gap in the case of various metal oxides.⁷⁵

Applying this method to the silicon L_{2,3} edge is problematic, since there are strong pre-edge features in the 2p XAS (around 107 to 109 eV). While not wishing to be limited by theory, these are either due to the final state core hole or excitons.⁷⁷ To avoid this complication, the main peak of the second derivative of the L_{2,3} XES spectrum has been used as an estimate for the valence band edge, and the main peak of the 2p XAS has been chosen as a reference for the lower conduction band edge—i.e., it was assumed that the main peak of the Si 2p XAS is the same energy above the true conduction band edge for all LPSi samples. The energy separation between the peak in the second derivative of the Si L_{2,3} XES and the main peak of the Si 2p XAS features is 10.3 eV, while the energy gap of amorphous SiO₂ is closer to 8.9 eV.⁷⁸ The peak in the Si 2p XAS does not correspond to the bottom of the conduction band, and, therefore, this method does not provide an estimate of the actual energy gap. However, comparing the shifts in this feature and in the peak in the second derivative of the Si L_{2,3} XES between the different materials should give a reasonably accurate estimate of the changes in the energy gap.

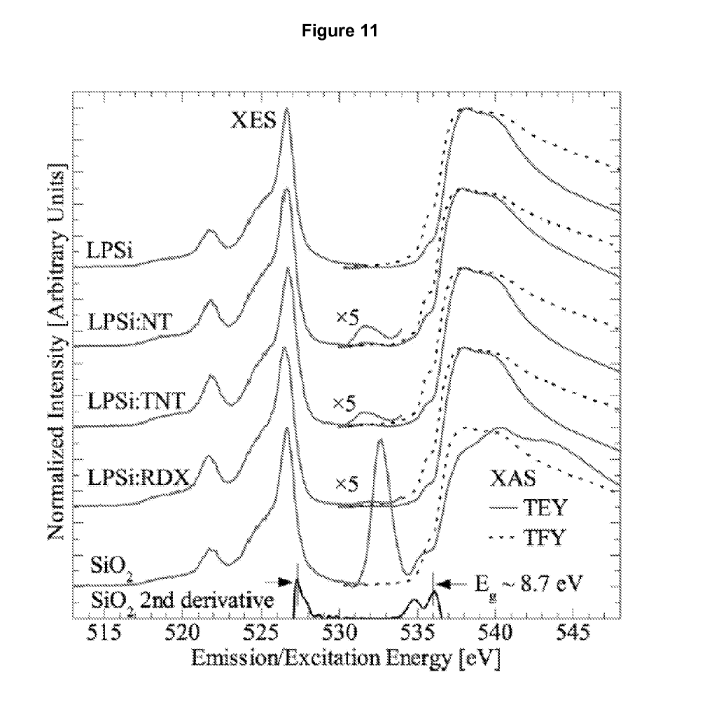

The second derivative of the Si L_{2,3} XES spectra near the valence band edge is shown in FIG. 10, where it is superimposed on the measured Si L_{2,3} XES spectra. The valence band edge of LPSi:NT, as estimated from the peak in the second derivative of the Si L_{2,3} XES spectrum, is about 0.4 eV higher than that of SiO₂, while the bottom of the conduction band, as estimated from the peak in the Si 2p XAS spectrum, also appears at slightly higher energies (by about 0.3 eV). This suggests that the surface energy gap of LPSi:NT is roughly 0.1 eV smaller than that of SiO₂. In the case of LPSi:TNT, the valence band edge, referenced to the Si 2p core states, is 1.5 eV higher than in SiO₂, while the bottom of the conduction band is only 0.4 eV higher than that of SiO₂. Thus, the surface energy gap of LPSi:TNT is roughly 1.1 eV smaller than that of SiO₂. Similar analysis of the LPSi:RDX spectra suggests that the energy gap in this system appears to be 1.2 eV larger than that in SiO₂. These dramatic changes are significant, but not unexpected for this system. It is clear from FIG. 4 and FIG. 11 that untreated LPSi has an energy gap close to that of c-Si in the bulk and that of SiO₂ on the surface, so there is a large change in electronic structure close to the surface. Changes in the porosity of pure silicon can affect the optical gap by approximately 0.3 eV,⁷⁹ and the energy gap of various polymorphs of SiO₂ can vary by as much as 4 eV.⁸⁰ In light of this, since the interface of c-Si with SiO₂ and Si bonded to various organic functional groups (possibilities include nitro, amine, methyl, and aromatic groups) is being probed in the present study, the large change in surface properties can be explained.

The large energy shifts evident in the Si L_{2,3} XES of treated LPSi suggest that the Si surface strongly interacts with the adsorbed molecules. The structure of NT, TNT, and RDX suggests that the nature of this interaction is driven by the formation of Si—O, Si—N, and/or Si—C bonds at the surface.

### Oxygen X-Ray Spectroscopy

The O K XES spectra of LPSi, LPSi:NT, LPSi:TNT, and LPSi:RDX are all quite similar to the spectrum of SiO₂, as shown in FIG. 11. The O 1s XAS bulk sensitive TFY spectra of the LPSi samples are also similar to the rather featureless TFY spectrum of SiO₂. The surface sensitive TEY spectra of the treated LPSi samples show some key differences from the TEY spectra of untreated LPSi and SiO₂. In particular, the untreated LPSi lacks the weak pre-edge feature at about 532 eV seen in the spectra of LPSi:NT, LPSi:TNT, and LPSi:RDX. In amino acids, this pre-edge feature is attributed to π* bonding.⁸¹ In SiO₂ there is a very strong pre-edge feature, although at higher energies (ca. 533 eV) than in treated LPSi. The O 1s XAS TEY spectrum of HPSi is again essentially the same as that of HPSi within 1.5 nm of the surface.

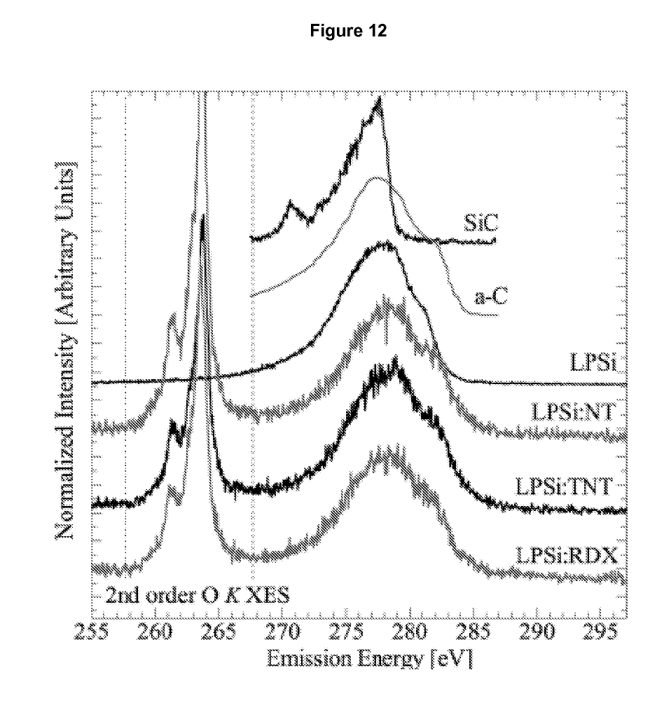

The main edge of the O 1s XAS spectrum of SiO₂ (at ca. 540 eV) is also slightly different from the corresponding edge in the LPSi samples. The second derivative method can be used on the O K XES and TFY mode O 1s XAS to estimate the energy gap. The TFY mode O 1s XAS spectra are more suited for this than the TEY mode O 1s XAS spectra, since the pre-edge peak in the latter obscure the true onset of the conduction band. This method suggests that the energy gap of SiO₂ is 8.7 eV, fairly close to the literature value of 8.9 eV.⁷⁸ Although the O K XES can likely probe deeper than the average pore depth, the Si L_{2,3} XES of untreated LPSi shows that the bulk material is crystalline silicon. Therefore, all the oxygen present in the untreated LPSi is on the surface, and, therefore, the O K XES and 1s XAS spectra are surface-sensitive. Since FIG. 4 shows that the silicon in untreated LPSi has electronic structure similar to c-Si, and since FIG. 12 shows that there is no second-order O K XES signal in the C K XES spectrum, there is minimal oxidation of the untreated LPSi surface. Since the O K XES and 1s XAS spectra shown in FIG. 11 probe the oxygen spectra explicitly, the limited surface oxidation in untreated LPSi is readily apparent. However, an accurate estimate of the relative concentration of oxygen in untreated and treated LPSi cannot be made using these spectra.

### Carbon X-Ray Spectroscopy

The C K XES spectra (see FIG. 12) show that the interaction between Si and C is fairly weak, indicating that no significant number of Si—C bonds are formed. This is evident from the weak C K XES spectra of LPSi:NT, LPSi:TNT, and LPSi:RDX. There is a strong contribution of the second order O K XES in the energy range from 258 to 266 eV, shown in FIG. 12. These oxygen features are absent in the spectrum of untreated LPSi and further demonstrate strong oxidation of LPSi upon exposure to nitro-based organic molecules. Further, the actual carbon K feature at 270-286 eV in the C K XES spectrum of the treated LPSi samples is similar to the spectrum of amorphous carbon (a-C) and very different from the spectrum of SiC. This suggests that the carbon present in the LPSi samples has mostly accumulated from exposure to the ambient environment, and is not strongly bonded to the LPSi surface.

To briefly summarize, the X-ray spectroscopy measurements of LPSi show sensitivity to the species of adsorbed molecule. There is clear evidence that exposure LPSi to NT, TNT, and RDX induces different degrees of oxidization and nitridization of the silicon surface, which causes a shift in the silicon band edge at the surface.

### Molecular Dynamics Calculations

To corroborate these experimental observations, an investigation of whether dissociative adsorption of molecules containing nitro groups at Si surfaces is plausible was undertaken. To this end, the interaction between pure and partially oxidized PSi and volatile molecules was first simulated with a molecular dynamics approach. This interaction was modeled using Si₂₉Oₓ (x=0, . . . , 4) clusters and the 1,1-diamino-2,2-dinitroethylene (DADNE) and dimethyl nitroamine (DMNA) molecules shown in Scheme 1.

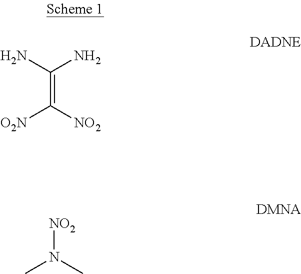

These molecules are relatively small so as to make the ab initio calculations feasible, yet, sufficiently complex to assist with interpretation of the experimental data. In particular, the DADNE molecule contains both amino and nitro groups and the DMNA molecule contains both methyl and nitro groups typically found in energetic materials. With respect to the NT, TNT, and RDX studied herein, DADNE has the same single bond C—NO₂ structure found in NT and TNT, while DMNA has the same single bond N—NO₂ structure present in RDX. Moreover, DADNE yields additional interest as it is a relatively new, highly energetic compound⁸² and its mechanical⁸³ and electronic^{84,85,86} properties and mechanisms of decomposition^{87,88,89} have been reported.

The Si₂₉ cluster has been developed as a model for PSi elsewhere⁹⁰ and employed previously in, for example, the simulation of atomic force microscopy tip interaction with alkali-halide surfaces.⁹¹ The effect of partial oxidation was investigated by calculating the geometrical structures and electronic properties of Si₂₉Oₓ (x=1-4) clusters (see above for details). In each case the geometrical structure of the Si₂₉Oₓ cluster was fully relaxed using the hybrid B3LYP density functional^{92,93} and Pople's 6-31G(d) basis set, as implemented in the Gaussian 03 package.⁶⁵ The energy gain due to reaction with each O atom is calculated with respect to the half of the total energy of an isolated O₂ molecule. Although a real porous silicon surface prepared by HF may have a hydride layer, the coverage of this layer depends on the preparation conditions and the layer itself is unstable and easily replaced by other species.⁹⁴ A surface hydride layer was therefore not included on the Si₂₉ cluster as such an addition would greatly increase the degrees of freedom of the system, and consequently the calculation time.

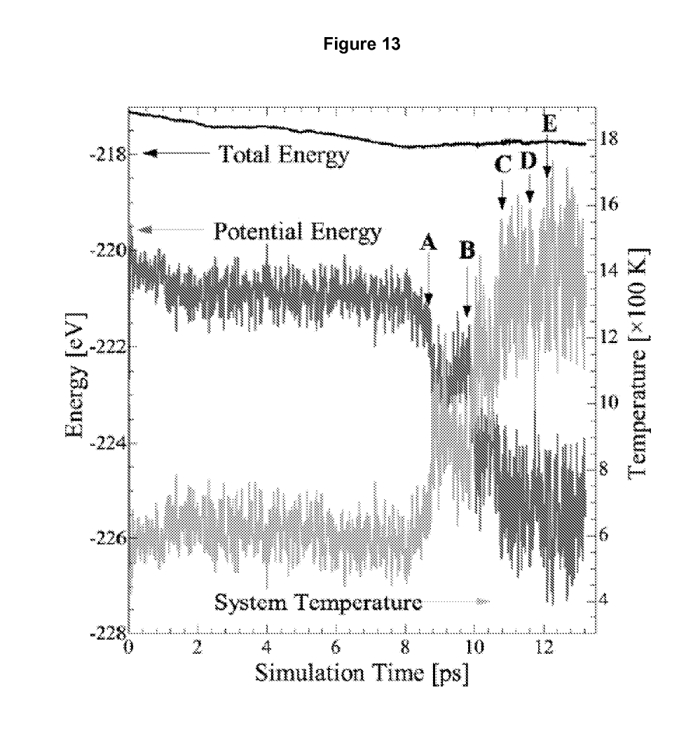

The time evolution of the system's potential energy and temperature, the latter being equivalent to the system kinetic energy, are shown in FIG. 13. The two plots anti-correlate, so the total energy of the system remains constant within the numerical noise of these calculations. The Si₂₉ cluster and the DADNE molecules are separated at the beginning of the simulation and the interaction between them is negligible up until approximately 8 ps of the simulation time. During this period the cluster is stationary and the molecule, as a whole, moves slowly across the supercell. The initial kinetic energies of atoms were set up so that the system temperature at this stage was approximately twice that of the room temperature (see FIG. 13).

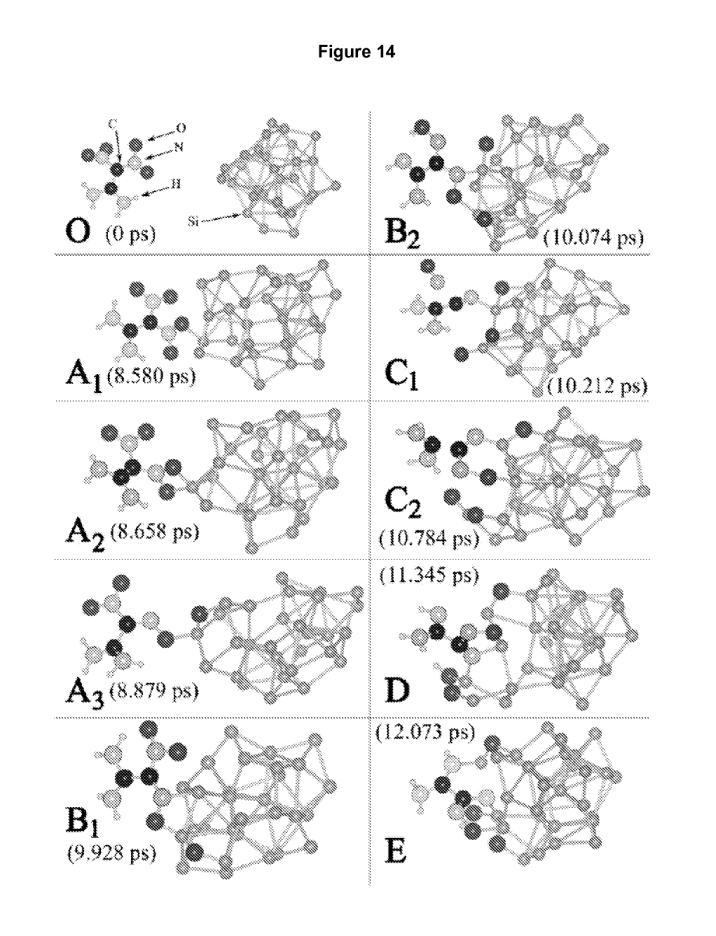

At approximately 8 ps of the simulation time (FIG. 13), the DADNE molecule approaches the Si₂₉ cluster with one of its NO₂ groups oriented toward the cluster atoms. The interaction between the cluster and the molecule nitro-groups induces several events indicated as “A” in FIG. 13, which take place consecutively (shown schematically in panels A₁ through A₃ in FIG. 14): 1) the formation of the first O—Si bond, 2) the formation of the second O—Si bond, whereby a N—O—Si—O cycle is created, and 3) the insertion of one O atom into a neighboring Si—Si bond, with the formation of a N—O—Si—O—Si fragment.

During this time the remainder of the DADNE molecule is attached to the Si cluster and its dynamics is coupled to that of the cluster. As the system continues to evolve in time, two events indicated as “B” occur (shown schematically in panels B₁ and B₂ in FIG. 14): 1) the displacement of a single Si atom towards the DADNE molecule and formation of bonds with an N atom of the first, now decomposed, NO₂ group and an O atom of the second, still intact, NO₂ group, and 2) the displacement of the same Si atom back towards the cluster so the O—N bond in the NO₂ group is broken and new Si—O—Si bonds are formed. At this stage, three out of four O atoms of the DADNE molecule are bonded to Si atoms of the cluster and consequent processes involve N as well as C atoms in the remains of the DADNE molecule.

In event “C”, a NO complex, which is the only surviving fragment of the original DADNE nitro groups, splits from the system and becomes a gas-phase NO molecule (shown in panel C₁ in FIG. 14). Such molecules are often observed among the products of detonated organic explosives. In the present case, the NO molecule binds to the surface of the silicon cluster, thus forming a six membered Si—O—N—C—N—Si ring (shown in panel C₂ in FIG. 14).

Events “D” and “E” correspond to the formation of the first Si—N—Si fragment and the switching of one N—Si bond, respectively (shown in panels D and E in FIG. 14, respectively).

Events “A” and “B” result in substantial potential energy gains, which is transferred to the temperature gains. Potential energy gains of similar magnitude follow events “C” and “E”. However, by this stage the system heats up to over 1400 K (see FIG. 13), which is less than 300 K below silicon melting temperature. Consequently, further oxidation and nitrogenation events are suppressed.

These results suggest that organic molecules containing nitro groups actively react with amorphous Si, oxidize and nitridize its surface, and decompose in the process. However, other structural elements of the molecule, such as amino-groups and the C═C backbone in the case of DADNE molecules, can remain intact in the process of the Si-molecule interaction. Earlier experimental studies have demonstrated that X-ray spectra of conglomerates of organic molecules are often merely a superposition of the spectra of individual molecules and functional groups.⁹⁵ In the present case, the dramatic changes observed in the Si L_{2,3} XES spectra upon exposure of LPSi to the molecules containing nitro-groups also point to dissociative adsorption of these molecules. Similar dissociative adsorption has been demonstrated theoretically for nitroamine molecules at the Al(111) surface.⁹⁶

In the present study, similar MD simulations have been carried out for the DMNA molecule and the Si₂₉ cluster. In this case, the molecule adsorbs at the surface but, unlike DADNE, the NO₂ group does not decompose within the simulation time. This difference in the DADNE-Si₂₉ and DMNA-Si₂₉ interaction correlates with the difference between the spectral shifts observed for NT and TNT and those observed for RDX. However, due to the limited MD simulation time and a qualitative model of the LPSi used in these calculations, the atomistic origin of the difference in the spectral shifts remain unidentified.

Finally, the effect of partial oxidation on both the electronic structure of the silicon cluster and on the interaction of the DADNE and DMNA molecules with the oxidized silicon cluster Si₂₉Oₓ was considered. To keep the calculations feasible, the value of x was varied between 1 and 4 and the changes of the geometrical structures and of the DOS with increasing x (see above) were monitored. The interaction of the DADNE and DMNA molecules with the Si₂₉O₄ cluster, as modeled using the MD approach, is very similar to that with the Si₂₉ cluster: the DADNE molecule gradually decomposes at the Si₂₉O₄ cluster surface, while the DMNA molecule remains intact during an equally long simulation time. While not wishing to be limited by theory, this can be explained taking into account that the electronic structure of the Si₂₉O₄ cluster is very similar to that of pure Si₂₉ cluster in that it contains many non-oxidized surface silicon atoms.

### Electronic Structure Calculations

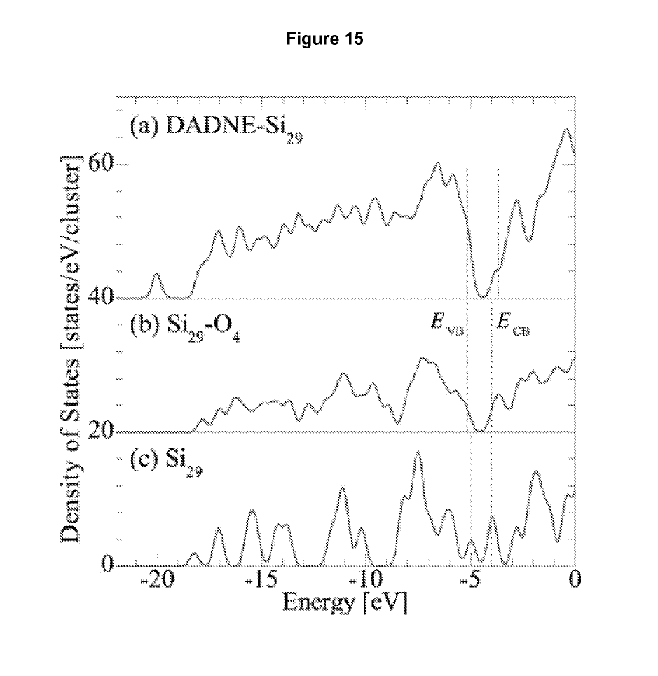

To analyze the electronic structure changes induced by the decomposition of DADNE on amorphous Si, the DOSs have been calculated for each of the configurations shown in FIG. 14, as discussed in the Materials and Methods Section (see above). Due to a highly irregular character of the Si cluster surface, detailed analysis of these changes is complicated. Nevertheless, it is apparent that formation of a single Si—O bond (FIG. 14, 8.580 ps) results in a noticeable depletion of the density of states near the gap between the highest occupied and lowest unoccupied states (referred to as the HOMO-LUMO gap). The gap shifts to the lower energies when two oxygen atoms bind to the same Si atom (FIG. 14, 8.658 ps) and widens when one of these oxygens also binds to another Si atom (FIG. 14, 8.879 ps). As DADNE decomposition progresses, the lower valence band states become apparent, the upper valence band gradually becomes featureless (similar to that of amorphous SiO₂), and the HOMO-LUMO gap increases, as shown in FIG. 15.

The changes in electronic structure due to the DADNE decomposition on Si₂₉—O₄ are similar to those arising due to the DADNE decomposition on Si₂₉, as illustrated by the DOS calculated for the Si₂₉O₄ and Si₂₉-DADNE systems (FIG. 15). These changes support the experimental findings (see FIG. 10) that treatment with various molecules shifts the Si L_{2,3} XES in energy but does not significantly change the shape of the emission. The valence band edge is shifted to lower energies with respect to pristine Si₂₉ in both the Si₂₉-DADNE and Si₂₉Oₓ systems, while only the Si₂₉-DADNE system shows a shift to the higher energies in the conduction band edge as compared to the pristine Si₂₉ cluster. This supports the findings that treatment with various molecules can cause a greater change in the surface electronic structure than O₂-induced oxidation alone.

The overall energy gain due to dissociative DADNE decomposition (see above) is about 12 eV, which is comparable to the overall energy gain upon reaction of Si₂₉ with two oxygen molecules and formation of the Si₂₉O₄ cluster (ca. 12.8 eV). However, the former, according to the present simulations, takes place rapidly and spontaneously at temperatures much lower than those used for Si oxidation. Hence, one can expect that reaction of the LPSi with the molecules containing nitro groups proceeds more rapidly than reaction with molecular O₂.

(c) Discussion

The observed effects of the adsorption of nitro-based molecules on the LPSi substrate are summarized in Table 1. In Table 1, E_{g} is the estimated energy gap, derived from the deviations in the Si L_{2,3} XES and Si 2p XAS from those of SiO₂ (with a measured energy gap of 8.7 eV). ΔE_{vb} and ΔE_{cb} are the shifts in the valence and conduction band edges, respectively. C:O is the estimated ratio between the quantity of surface carbon and oxygen; errors in this quantity were estimated based on the amount of statistical noise in the measurement and the inherent energy uncertainty.

TABLE 1
Summary of the differences in X-ray spectra

| | E_{g} | ΔE_{vb} | ΔE_{cb} | C:O |
|---|---|---|---|---|
| | [±0.5 eV] | [±0.1 eV] | [±0.1 eV] | [±0.01] |
| LPSi:NT | 8.6 | 0.4 | 0.3 | 1.31 |
| LPSi:TNT | 7.2 | 1.5 | 0.4 | 1.75 |
| LPSi:RDX | 9.9 | −0.8 | 0.4 | 1.48 |

Regarding the mechanism behind these effects: Si—Si bonds in porous silicon can be broken to form Si—C bonds,⁹⁷ Si—N bonds tend to replace Si—C bonds,⁹⁸ and Si—O bonds are even more energetically favorable.⁹⁹ Since the observed spectral shifts are due not only to the functional groups of the adsorbed molecules (i.e. the differences between the spectra of LPSi:RDX and LPSi:TNT) but also the affinity of that molecule to be absorbed (i.e. the differences between the spectra of LPSi:TNT and LPSi:NT), the mechanisms behind the present observations can be proposed.

With this in mind, the C:O ratio in Table 1 (the ratio between the total intensity of the C K XES and the second order O K XES signal visible in the same spectrum) can be used as an estimate of the relative amount of carbon compared to oxygen between the treated LPSi samples. From the C K XES spectra, this ratio is the lowest for LPSi:NT, and the highest for LPSi:TNT, with LPSi:RDX somewhere in between. The C:O ratio per molecule is 7/2 for NT, 7/6 for TNT, and 3/6 for RDX. However, the actual adsorbed C:O ratio for the treated LPSi depends on the adsorption affinity for each molecule.

The MD simulations of the present study show that C attaches to the Si surface through a N atom (in DADNE) or a NO₂ group (in DMNA). Therefore, the larger the number of NO₂ groups per cyclic ring, the greater the chance that the ring will stay attached to the Si surface. While a single N/NO₂—Si bond can leave the aromatic ring out of contact with the Si surface (in the case of NT), two or more N/NO₂—Si bonds will bring the aromatic ring at least partially in plane with the Si surface (in the case of TNT). This close contact with the Si surface presents the opportunity for more bonds (Si—N or even Si—C) to form. Therefore even though the product of the molecular C:O ratio and the number of NO₂ groups is the same for both NT and TNT (7/2×1 for NT, and 7/6×3 for TNT) more TNT can be expected to be retained on the Si surface than NT. In fact, the experimental data of the present study suggests that ˜1.33 TNT molecules are adsorbed for every NT molecule (see Table 1).

Because RDX and TNT have the same number of NO₂ groups, all else being equal, based on the product of the molecular C:O ratios and the number of NO₂ groups it would be expected that LPSi would adsorb 7/3 TNT molecules for every RDX molecule (the ratio of 7/6×3 for TNT and 3/6×3 for RDX). However, the cyclic part of the RDX molecules can, in principle, adsorb to the Si surface via either NO₂ or, if the NO₂ groups dissociate, via the N atoms in the cyclic ring. Hence the number of potential bonding sites in RDX is twice that of TNT. This implies the ratio of adsorbed TNT molecules to adsorbed RDX molecules should be closer to 7/6. This is quite close to the ratio of the measured adsorbed C:O for TNT and RDX (ca. 1.18) in Table 1.

While the present disclosure has been described with reference to what are presently considered to be the preferred examples, it is to be understood that the disclosure is not limited to the disclosed examples. To the contrary, the present disclosure is intended to cover various modifications and equivalent arrangements included within the spirit and scope of the appended claims.

### FULL CITATIONS FOR DOCUMENTS REFERRED TO IN THE SPECIFICATION

¹ J. Yinon, TrAC Trends Anal. Chem. 2002, 21, 292.
² J. I. Steinfeld, J. Wormhoudt, Annu. Rev. Phys. Chem. 1998, 49, 203.
³ G. Vourvopoulos, P. C. Womble, Talanta 2001, 54, 459.
⁴ R. G. Ewing, D. A. Atkinson, G. A. Eiceman, G. J. Ewing, Talanta 2001, 54, 515.
⁵ B. L. Allen, P. D. Kichambare, A. Star, Carbon nanotube field-effect-transistor-based biosensors. Adv. Mater. 2007, 19, 1439.
⁶ L. N. Cella, W. Chen, N. V. Myung, A. Mulchandani, Single-walled carbon nanotube-based chemiresistive affinity biosensors for small molecules: Ultrasensitive glucose detection. J. Am. Chem. Soc. 2010, 132, 5024.
⁷ T. H. Kim, B. Y. Lee, J. Jaworski, K. Yokoyama, W. J. Chung, E. Wang, S. Hong, A. Majumdar, S. W. Lee, ACS Nano 2011, 26, 2824.
⁸ H. Lin, K. S. Suslick, A colorimetric sensor array for detection of triacetone triperoxide vapor. J. Am. Chem. Soc. 2010, 132, 15519.
⁹ M. B. Pushkarsky, I. G. Dunayevskiy, M. Prasanna, A. G. Tsekoun, R. Go, C. K. N. Patel, Proc. Natl. Acad. Sci. USA 2006, 103, 19630.
¹⁰ H. Ko, S. Chang, V. V. Tsukruk, Porous substrates for label-free molecular level detection of nonresonant organic molecules. ACS Nano 2009, 3, 181.
¹¹ J.-S. Yang, T. M. Swager, J. Am. Chem. Soc. 1998, 120, 11864.
¹² T. Naddo, Y. Che, W. Zhang, K. Balakrishnan, X. Yang, M. Yen, J. Zhao, J. S. Moore, L. Zang, Detection of explosives with a fluorescent nanofibril film. J. Am. Chem. Soc. 2007, 129, 6978.
¹³ A. Rose, Z. Zhu, C. F. Madigan, T. M. Swager, V. Bulović, Sensitivity gains in chemosensing by lasing action in organic polymers. Nature 2005, 434, 876.
¹⁴ Y. Yang, G. A. Turnbull, I. D. W. Samuel, Sensitive explosive vapor detection with polyfluorene lasers. Adv. Funct. Mater. 2010, 20, 2093.
¹⁵ A. Narayanan, O. Varnayski, O. Mongin, J.-P. Majoral, M. Blanchard-Desce, T. Goodson III, Detection of TNT using a sensitive two-photon organic dendrimer for remote sensing. Nanotechnology 2008, 19, 115502.
¹⁶ J. C. Sanchez, W. C. Trogler, Efficient blue-emitting silafluorene-fluorene-conjugated copolymers: selective turn-off/turn-on detection of explosives. J. Mater. Chem. 2008, 18, 3143.
¹⁷ W. Theiβ, Optical properties of porous silicon. Surf. Sci. Rep. 1997, 29, 91.
¹⁸ J. K. Chun, A. B. Bocarsly, T. R. Cottrell, J. B. Benziger, J. C. Yee, Proton gated emission from porous silicon. J. Am. Chem. Soc. 1993, 115, 3024.
¹⁹ J. M. Lauerhaas, G. M. Credo, J. L. Heinrich, M. J. Sailor, Reversible luminescence quenching of porous Si by solvents. J. Am. Chem. Soc. 1992, 114, 1911.
²⁰ J. H. Song, M. J. Sailor, Quenching of photoluminescence from porous silicon by aromatic molecules. J. Am. Chem. Soc. 1997, 119, 7381.
²¹ B. Sweryda-Krawiec, R. R. Chandler-Henderson, J. L. Coffer, Y. G. Rho, R. F. Pinizzotto, A comparison of porous silicon and silicon nanocrystallite photoluminescence quenching with amines. J. Phys. Chem. 1996, 100, 13776.
²² J. M. Lauerhaas, M. J. Sailor, Chemical modification of the photoluminescencel quenching of porous silicon. Science 1993, 261, 1567.
²³ V. S.-Y. Lin, K. Motesharei, K.-P. S. Dancil, M. J. Sailor, M. R. Ghadiri, A porous silicon-based optical interferometric biosensor. Science 1997, 278, 840.
²⁴ V. Yu. Timoshenko, Th. Dittrich, V. Lysenko, M. G. Lisachenko, F. Koch, Phys. Rev. B 2001, 64, 085314.
²⁵ I. A. Levitsky, W. B. Euler, N. Tokranova, A. Rose, Appl. Phys. Lett. 2007, 90, 041904.
²⁶ P. A. Snow, E. K. Squire, P. St. J. Russell, L. T. Canham, J. Appl. Phys. 1999, 86, 1781.
²⁷ J. Saarinen, S. Weiss, P. Fauchet, J. E. Sipe, Optics Express 2005, 13, 3754.
²⁸ V. Mulloni, L. Pavesi, Appl. Phys. Lett. 2000, 76, 2523.
²⁹ C. Pacholski, M. Sartorand, M. J. Sailor, F. Cunin, G. M. Miskelly, J. Am. Chem. Soc. 2005, 127, 11636.
³⁹ L. De Stefano, I. Rednina, L. Moretti, S. Tundo, A. M. Rossi, Appl. Opt. 2004, 43, 167.
³¹1. G. Kolobov, W. B. Euler, I. A. Levitsky, Appl. Opt. 2010, 49, 137.
³² L. De Stefano, I. Rendina, L. Moretti, S. Tundo, A.M. Rossi, Smart optical sensors for chemical substances based on porous silicon technology. Optics Express 2004, 43, 1.
³³ D. R. Huanca, F. J. Ramirez-Fernandez, W. J. Salcedo, Porous silicon optical cavity structure applied to high sensitivity organic solvent sensor. Microelectronics Journal 2008, 39, 499.
³⁴ L. Seals, J. L. Gole, L. A. Tse, P. J. Hesketh, J. Appl. Phys. 2002, 91, 2519.
³⁵ G. Barillaro, A. Diligenti, G. Marola, L. M. Stambini, A silicon crystalline resistor with an adsorbing porous layer as gas sensor. Sensors and Actuators B 2005, 105, 278.
³⁶ P. Fürjes, A. Kovacs, Cs. Ducso, M. Adam, B. Muller, U. Mescheder, Porous silicon-based humidity sensor with interdigital electrodes and internal heaters. Sensors and Actuators B 2003, 95, 140.
³⁷ S. Green, P. Kathirgamanathan, Effect of oxygen on the surface conductance of porous silicon: Towards room temperature sensor applications. Materials Letters 2002, 52, 106.
³⁸ P. G. Han, H. Wong, M. G. Poon, Sensitivity and stability of a porous polycrystalline silicon gas sensor. Colloids and Surfaces A 2001, 179, 171.
³⁹ S. Khoshnevis, R. S. Dariani, M. E. Azim-Araghi, Z. Bayindir, K. Robbie, Observation of oxygen gas effect on porous silicon-based sensors. Thin Solid Films 2006, 515, 2650.
⁴⁰ P. J. Hesketh, S. Lewis, J. Gole, J. DeBoer, Selective, sensitive, and tunable porous silicon gas sensor, Electrochemical Society 2004 Joint International Meeting, Oct. 3-8, 2004, Abstract No. 2565.
⁴¹ PCT Publication No. WO 2010/022321.
⁴² J. Harper, M. J. Sailor, Detection of Nitric Oxide and Nitrogen Dioxide with Photoluminescent Porous Silicon. Anal. Chem. 1996, 68, 3713.
⁴³ L. Boarino, C. Baratto, F. Geobaldo, G. Amato, E. Comini, A. M. Rossi, G. Faglia, G. Lérondel, G. Sberveglieri, NO₂ monitoring at room temperature by a porous silicon gas sensor. Mater. Sci. Eng. B 2000, 69, 210.
⁴⁴ C. Baratto, G. Faglia, E. Comini, G. Sberveglieri, A. Taroni, V. La Ferrara, L. Quercia, G. Di Francia, A novel porous silicon sensor for detection of sub-ppm NO₂ concentrations. Sens. Actuators B 2001, 77, 62.
⁴⁵ L. Pancheri, C. J. Oton, Z. Gaburro, G. Soncini, L. Pavesi, Very sensitive porous silicon NO₂ sensor. Sens. Actuators B 2003, 89, 237.
⁴⁶ Improved reversibility in aged porous silicon NO₂ sensors. L. Pancheri, C. J. Oton, Z. Gaburro, G. Soncini, L. Pavesi, Sens. Actuators B 2004, 97, 45.
⁴⁷ C. S. Sharov, E. A. Konstantinova, L. A. Osminkina, V. Y. Timoshenko, P. K. Kashkarov, Chemical Modification of a Porous Silicon Surface Induced by Nitrogen Dioxide Adsorption. J. Phys. Chem. B 2005, 109, 4684.
⁴⁸ I. A. Levitsky, Highly sensitive and selective explosive detector based on nanoporous silicon photonic crystal infiltrated with emissive organics. IEEE Nanotechnology Magazine September 2010, 24.
⁴⁹ S. Content, W. C. Trogler, M. J. Sailor, Detection of nitrobenzene, DNT and TNT vapors by quenching of porous silicon photoluminescence. Chem. Eur. J. 2000, 6, 2205.
⁵⁰ A. G. Cullis, L. T. Canham, P. D. J. Calcott, J. Appl. Phys. 1997, 82, 909.
⁵¹ O. Bisi, S. Ossicini, and L. Pavesi. Surface Science Reports, 38:1, 2000.
52 B. L. Henke, E. M. Gullikson, and J. C. Davis. Atomic Data and Nuclear Data Tables, 54:181, 1993.
⁵³ I. Lindau and W. E. Spicer. J. Electron Spectrosc. Relat. Phenom., 3:409, 1974.
⁶⁴ J. J. Jia, T. A. Callcott, J. Yurkas, A. W. Ellis, F. J. Himpsel, M. G. Samant, J. Stöhr, D. L. Ederer, J. A. Carlisle, E. A. Hudson, L. J. Terminello, D. K. Shuh, R. C. C. Perera, Rev. Sci. Instrum. 1995, 66, 1394.
⁶⁶ T. Regier, J. Krochak, T. K. Sham, Y. F. Hu, J. Thompson, R. I. R. Blyth, Nucl. Instrum. Methods Phys. Res. Sect. A 2007, 582, 93.
⁵⁶ Y. F. Hu, L. Zuin, G. Wright, R. Igarashi, M. McKibben, T. Wilson, S. Y. Chen, T. Johnson, D. Maxwell, B. W. Yates, T. K. Sham, R. Reininger, Rev. Sci. Instrum. 2007, 78, 083109.
⁶⁷ T.-K. Sham and R. A. Rosenberg. Chemphyschem, 8:2557, 2007.
⁵⁸ L. A. J. Garvie and P. R. Buseck. Am. Mineral., 84:946, 1999.
⁶⁹ D. A. Zatsepin, S. Kaschieva, M. Zier, B. Schmidt, and H.-J. Fitting. Phys. Status Solidi A, 207:743, 2010.
⁶⁰ S.-I. Nakai, T. Mitsuishi, H. Maezawa, T. Matsukawa, S. Mitani, K. Yamasaki, and T. Fujikawa. Phys. Rev. B, 36:9241, 1987.
⁶¹ A. Kikas, T. Käämbre, V. Kisand, A. Saar, K. Kooser, E. Nömmiste, and I. Martinson. J. Electr. Spec. Relat. Phenom, 144:845, 2005.
⁶² J. P. Perdew, K. Burke, M. Ernzerhof, Generalized gradient approximation made simple. Phys. Rev. Lett. 1996, 77, 3865-3868.
⁶³ P. E. Blöchl, Projector augmented-wave method. Phys. Rev. B 1994, 50, 17953-17979.
⁶⁴ G. Kresse, J. Furthmüller, Efficient iterative schemes for ab initio total-energy calculations using a plane-wave basis set. Phys. Rev. B 1996, 54, 11169-11186.
⁶⁵ Gaussian 03 (Revision D.02), M. J. Frisch, G. W. Trucks, H. B. Schlegel, G. E. Scuseria, M. A. Robb, J. R. Cheeseman, J. A. Montgomery Jr., T. Vreven, K. N. Kudin, J. C. Burant, J. M. Millam, S. S. Iyengar, J. Tomasi, V. Barone, B. Mennucci, M. Cossi, G. Scalmani, N. Rega, G. A. Petersson, H. Nakatsuji, M. Hada, M. Ehara, K. Toyota, R. Fukuda, J. Hasegawa, M. Ishida, T. Nakajima, Y. Honda, O. Kitao, H. Nakai, M. Klene, X. Li, J. E. Knox, H. P. Hratchian, J. B. Cross, V. Bakken, C. Adamo, J. Jaramillo, R. Gomperts, R. E. Stratmann, O. Yazyev, A. J. Austin, R. Cammi, C. Pomelli, J. W. Ochterski, P. Y. Ayala, K. Morokuma, G. A. Voth, P. Salvador, J. J. Dannenberg, V. G. Zakrzewski, S. Dapprich, A. D. Daniels, M. C. Strain, O. Farkas, D. K. Malick, A. D. Rabuck, K. Raghavachari, J. B. Foresman, J. V. Ortiz, Q. Cui, A. G. Baboul, S. Clifford, J. Cioslowski, B. B. Stefanov, G. Liu, A. Liashenko, P. Piskorz, I. Komaromi, R. L. Martin, D. J. Fox, T. Keith, M. A. Al-Laham, C. Y. Peng, A. Nanayakkara, M. Challacombe, P. M. W. Gill, B. Johnson, W. Chen, M. W. Wong, C. Gonzalez, J. A. Pople, Gaussian Inc., Wallingford Conn., USA, 2004.
⁶⁶ O. Bisi, S. Ossicini, L. Pavesi, Surf. Sci Rep. 2000, 38, 1.
⁶⁷ J. Mizsei, Thin Solid Films 2007, 515, 8310.
⁶⁸ Y. Wang, J. Too, S. Tong, T. Sun, A. Zhang, The oxidation kinetics of thin polycrystalline silicon films. J. Electrochem. Soc. 1991, 138, 214-219.
⁶⁹ D.-B. Kao, J. P. McVittie, W. D. Nix, K. C. Saraswat, Two-dimensional thermal oxidation of silicon—i. experiments. IEEE Trans. Electron Devices 1987, 34, 1008-1017.
⁷⁰ D.-B. Kao, J. P. McVittie, W. D. Nix, K. C. Saraswat, Two-dimensional thermal oxidation of silicon—ii. modeling stress effects in wet oxides. IEEE Trans. Electron Devices 1988, 35, 25-37.
⁷¹ A. E. Pap, K. Kordás, G. Tóth, J. Levoska, A. Uusimäki, J. Vähäkangas, S. Leppävuori, T. F. George, Thermal oxidation of porous silicon: Study on structure. Appl. Phys. Lett. 2005, 86, 041501.
⁷² K. Barla, R. Herino, G. Bomchil, Stress in oxidized porous silicon layers. J. Appl. Phys. 1986, 59, 439.
⁷³ W. Theiβ, Optical properties of porous silicon. Surf. Sci. Rep. 1997, 29, 91.
⁷⁴ S. E. Létant, T. W. van Buuren, L. J. Terminello, Nano Lett. 2004, 4, 1705.
⁷⁶ E. Z. Kurmaev, R. G. Wilks, A. Moewes, L. D. Finkelstein, S, N. Shamin, J. Kunes, Phys. Rev. B 2008, 77, 165127.
⁷⁶ K. Ogasawara, I. Tanaka, H. Adachi, Adv. Quantum Chem. 1998, 29, 441.
⁷⁷ R. Buczko, G. Duscher, S. J. Pennycook, S. T. Pantelides, Phys. Rev. Lett. 2000, 85, 2168.
⁷⁸ T. H. DiStefano, D. E. Eastman, Solid State Commun. 1971, 9, 2259.
⁷⁹ C. Rotaru, N. Tomozeiu, G. Craciun, J. Mol. Struct. 1999, 480-481, 293.
⁸⁰ Y.-N. Xu, W. Y. Ching, Phys. Rev. B 1991, 44, 11048.
⁸¹ M. Tanaka, K. Nakagawa, T. Koketsu, A. Agui, A. Yokoya, J. Synchrotron Radiat. 2001, 8, 1009.
⁸² U. Bemm, H. Östmark, Acta Crystallogr. Sect. C 1998, 54, 1997.
⁸³ F. J. Zerilli, M. M. Kuklja, First principles calculation of the mechanical compression of two organic molecular crystals. J. Phys. Chem. A 2006, 110, 5173-5179.
⁸⁴ M. M. Kuklja, S, N. Rashkeev, Shear-strain-induced chemical reactivity of layered molecular crystals. Appl. Phys. Lett. 2007, 90, 151913.
⁸⁵ A. V. Kimmel, P. V. Sushko, M. M. Kuklja, A. L. Shluger, An effect of charged and excited state on the decomposition of 1,1-diamino-2,2,dinitroethylene molecules. J. Chem. Phys. 2007, 126, 234711.
⁸⁶ A. V. Kimmel, D. Muñoz Ramo, P. V. Sushko, A. L. Shluger, M. M. Kuklja, Modeling proton transfer and polarons in a molecular crystal diamino-dinitroethylene. Phys. Rev. B 2009, 80, 134108.
⁸⁷ P. Politzer, M. C. Concha, M. E. Grice, J. S. Murray, P. Lane, D. Habibollazadeh, J. Mol. Struct.: THEOCHEM 1998, 452, 75-83.
⁸⁸ A. Gindulytè, L. Massa, L. Huang, J. Karle, J. Phys. Chem. A 1999, 103, 11045.
⁸⁹ M. M. Kuklja, S, N. Rashkeev, Shear-strain-induced structural and electronic modifications of the molecular crystal 1,1-diamino-2,2-dinitroethylene: Slip-plane flow and band gap relaxation. Phys. Rev. B 2007, 75, 104111.
⁹⁰ J. L. Gavartin, C. C. Matthai, I. Morrison, The influence of the spatial structure on the electronic properties of porous silicon: quantum chemical study. Thin Solid Films 1995, 255, 39-42.
⁹¹ P. V. Sushko, A. S. Foster, L. N. Kantorovich, A. L. Shluger, Investigating the effects of silicon tip contamination in noncontact scanning force microscopy (SFM). Appl. Surf. Sci. 1999, 144-145, 608-612.
⁹² C. Lee, W. Yang, R. G. Parr, Development of the Colle-Salvetti correlation-energy formula into a functional of the electron density. Phys. Rev. B 1988, 37, 785-789.
⁹³ A. D. Becke, Density functional thermochemistry. III. The role of exact exchange. J. Chem. Phys. 1993, 98, 5648-5652.
⁹⁴ R. Boukherroub, S. Szunerits, Electrochemistry at nanoscale, chapter Wet Chemical Approaches for Chemical Functionalization of Semiconductor Nanostructures. Springer Science-+Business Media, LLC, 2009.
⁹⁵ J. Boese, A. Osanna, C. Jacobsen, J. Kirz, J. Electron Spectrosc. Relat. Phenom. 1997, 85, 9.
⁹⁶ S.-Q. Zhou, F.-Q. Zhao, X.-H. Ju, X.-C. Chen, J.-H. Yi, J. Phys. Chem. C 2010, 114, 9390.
⁹⁷ J. H. Song, M. J. Sailor, Functionalization of nanocrystalline porous silicon surfaces with aryllithium reagents: Formation of silicon-carbon bonds by cleavage of silicon-silicon bonds. J. Am. Chem. Soc. 1998, 120, 2376.
⁹⁸ C. W. Chen, C. C. Huang, Y. Y. Lin, L. C. Chen, K. H. Chen, Diamond Relat. Mater. 2005, 14, 1126.
⁹⁹ W. L. Scopel, M. C. A. Fantini, M. I. Alayo, I. Pereyra, Thin Solid Films 2002, 413, 59.

We claim:

1. A method of selectively detecting the presence of at least one compound in a gaseous medium, the method comprising:
exposing a silicon substrate to the gaseous medium under conditions to adsorb the at least one compound to the silicon substrate to form a modified silicon substrate; and
analyzing the modified silicon substrate to determine if the at least one compound was present in the gaseous medium,
wherein the step of analyzing comprises using X-ray spectroscopy.

2. The method of claim 1, wherein the step of analyzing comprises obtaining an X-ray spectroscopic measurement of the modified silicon substrate, and comparing the X-ray spectroscopic measurement of the modified silicon substrate to an X-ray spectroscopic reference standard.

3. The method of claim 2, wherein the X-ray spectroscopic measurement is obtained using at least one of X-ray emission spectroscopy (XES) and X-ray absorption spectroscopy (XAS).

4. The method of claim 3, wherein the X-ray spectroscopic measurement is based on an Si L_{2,3} XES spectrum.

5. The method of claim 3, wherein the X-ray spectroscopic measurement is a change in an energy gap.

6. The method of claim 5, wherein the change in the energy gap is based on an Si L_{2,3} XES spectrum and an Si 2p XAS spectrum.

7. The method of claim 1, wherein the silicon substrate consists essentially of a mesoporous silicon.

8. The method of claim 1, wherein the silicon substrate consists essentially of a high porosity mesoporous silicon.

9. The method of claim 1, wherein the silicon substrate consists essentially of a low porosity mesoporous silicon.

10. The method of claim 1, further comprising, prior to the step of exposing, subjecting the silicon substrate to conditions to oxidize a surface thereof.

11. The method of claim 1, wherein the at least one compound is adsorbed to the silicon substrate through at least one of a chemisorption mechanism and a physisorption mechanism.

12. The method of claim 11, wherein the at least one compound is adsorbed to the silicon substrate through a chemisorption mechanism.

13. The method of claim 1, wherein the at least one compound comprises at least one chemical moiety that chemically reacts with the silicon substrate in the step of exposing to form the modified silicon substrate.

14. The method of claim 13, wherein the at least one chemical moiety is selected from the group consisting of a nitro group, a nitrite group, a peroxide group, an alcohol group, an amine group and a cyano group.

15. The method of claim 14, wherein the at least one compound is selected from the group consisting of nitramide, nitrobenzene, nitromethane, nitrotoluene, dinitrotoluene, trinitrotoluene, cyclotrimethylenetrinitramine, cyclotetramethylenetetranitramine, trinitrophenol, 1,1-diamino-2,2-dinitroethene, triaminotrinitrobenzene, nitroglycerin, ethylene glycol dinitrate, pentaerythritol tetranitrate, trinitrophenylmethylnitramine, hexanitrostilbene, 1,1-mercuric bis-5,5-nitrotetrazole, amyl nitrite, methyl nitrite, ethyl nitrite, methanol, ethanol, isopropanol and triacetone triperoxide.

16. The method of claim 14, wherein the at least one compound is selected from the group consisting of para-nitrotoluene, 2,4,6-trinitrotoluene and cyclotrimethylenetrinitramine.

17. The method of claim 1, wherein, in the step of exposing, the at least one compound is not capable of reacting with the silicon substrate under the conditions to adsorb the at least one compound to the silicon substrate.

18. The method of claim 17, wherein the at least one compound is a benzene-based compound.

19. The method of claim 18, wherein the benzene-based compound is selected from benzene and dichlorobenzene.

20. The method of claim 1, wherein the at least one compound is an explosive compound.

21. A method of selectively detecting the presence of at least one compound in a gaseous medium, the at least one compound comprising at least one chemical moiety selected from the group consisting of a nitro group, a nitrite group, a peroxide group, an alcohol group, an amine group and a cyano group, the method comprising:
exposing a silicon substrate to the gaseous medium under conditions to chemically react the at least one chemical moiety with the silicon substrate and adsorb the at least one compound to the silicon substrate to form a modified substrate;
obtaining an X-ray spectroscopic measurement of the modified substrate; and
comparing the X-ray spectroscopic measurement of the modified substrate to an X-ray spectroscopic reference standard, in order to determine if the at least one compound was present in the gaseous medium.

22. A method of selectively detecting the presence of at least one compound in a gaseous medium, the at least one compound selected from the group consisting of para-nitrotoluene, 2,4,6-trinitrotoluene and cyclotrimethylenetrinitramine, the method comprising:
exposing a mesoporous silicon substrate to the gaseous medium under conditions to adsorb the at least one compound to the mesoporous silicon substrate to form a modified substrate;
obtaining an X-ray spectroscopic measurement of the modified substrate; and
comparing the X-ray spectroscopic measurement of the modified substrate to an X-ray spectroscopic reference standard, in order to determine if the at least one compound was present in the gaseous medium.
